(19) United States
(12) Patent Application Publication
(10) Pub. No.: US 2025/0119310 A1
(43) Pub. Date: Apr. 10, 2025

(54) EVENT MANAGEMENT SYSTEM, EVENT MANAGEMENT METHOD, AND NON-TRANSITORY RECORDING MEDIUM

(71) Applicant: Daiki NAKAMURA, KANAGAWA (JP)

(72) Inventor: Daiki NAKAMURA, KANAGAWA (JP)

(21) Appl. No.: 18/908,840

(22) Filed: Oct. 8, 2024

(30) Foreign Application Priority Data
Oct. 10, 2023 (JP) 2023-174922

(51) Int. Cl. H04L 12/18

(52) U.S. Cl. CPC H04L 12/1822

(57) ABSTRACT

An event management system includes a first communication terminal, a second communication terminal, and an event management apparatus. The first communication terminal is located in a physical space and used for executing a predetermined event. The second communication terminal is used for executing the predetermined event via a virtual space. The event management apparatus manages information related to the predetermined event in a case where the predetermined event is executed using the first communication terminal and the second communication terminal. The event management apparatus includes first circuitry configured to generate an event participation notification after one communication terminal of the first communication terminal and the second communication terminal performs processing of participating in the predetermined event and transmit the generated event participation notification to the other communication terminal.

### CROSS-REFERENCE TO RELATED APPLICATION

This patent application is based on and claims priority pursuant to 35 U.S.C. § 119(a) to Japanese Patent Application No. 2023-174922, filed on Oct. 10, 2023, in the Japan Patent Office, the entire disclosure of which is hereby incorporated by reference herein.

### BACKGROUND

### Technical Field

The present disclosure relates to an event management system, an event management method, and a non-transitory recording medium.

### Related Art

A recent technique allows a participant in a physical space and an avatar in a virtual space (virtual reality space) to participate in the same online meeting by using an application on a communication terminal located in the physical space.

For example, to indicate a response of a participant, a technique in the related art allows the participant to participate in a virtual meeting via a display.

### SUMMARY

According to one aspect, an event management system includes a first communication terminal, a second communication terminal, and an event management apparatus. The first communication terminal is located in a physical space and to be used for executing a predetermined event. The second communication terminal is to be used for executing the predetermined event via a virtual space. The event management apparatus manages information related to the predetermined event in a case where the predetermined event is executed using the first communication terminal and the second communication terminal The event management apparatus includes first circuitry configured to: generate an event participation notification after one communication terminal of the first communication terminal and the second communication terminal performs processing of participating in the predetermined event, the event participation notification being a notification prompting another communication terminal of the first communication terminal and the second communication terminal to participate in the predetermined event, the other communication terminal being a communication terminal that is scheduled to participate in and does not participate in the predetermined event yet; and transmit the generated event participation notification to the other communication terminal.

According to one aspect, an event management method is performed by an event management apparatus. The event management method includes managing information related to a predetermined event in a case where the predetermined event is executed using a first communication terminal and a second communication terminal, the first communication terminal being a communication terminal located in a physical space and to be used for executing the predetermined event, the second communication terminal being a communication terminal to be used for executing the predetermined event via a virtual space. The event management method includes generating an event participation notification after one communication terminal of the first communication terminal and the second communication terminal performs processing of participating in the predetermined event, the event participation notification being a notification prompting another communication terminal of the first communication terminal and the second communication terminal to participate in the predetermined event, the other communication terminal being a communication terminal that is scheduled to participate in and does not participate in the predetermined event yet. The event management method includes transmitting the generated event participation notification to the other communication terminal.

According to one aspect, a non-transitory recording medium stores a plurality of instructions which, when executed by one or more processors, causes the one or more processors to perform a method. The one or more processors is included in an event management apparatus. The method includes managing information related to a predetermined event in a case where the predetermined event is executed using a first communication terminal and a second communication terminal, the first communication terminal being a communication terminal located in a physical space and to be used for executing the predetermined event, the second communication terminal being a communication terminal to be used for executing the predetermined event via a virtual space. The method includes generating an event participation notification after one communication terminal of the first communication terminal and the second communication terminal performs processing of participating in the predetermined event, the event participation notification being a notification prompting another communication terminal of the first communication terminal and the second communication terminal to participate in the predetermined event, the other communication terminal being a communication terminal that is scheduled to participate in and does not participate in the predetermined event yet. The method includes transmitting the generated event participation notification to the other communication terminal.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a general arrangement of an information processing system according to a first embodiment of the present disclosure;

FIG. 2 is an overhead view of an example of a physical space (event space) according to the first embodiment;

FIG. 3 is an overhead view of an example of a virtual space (metaverse) according to the first embodiment;

FIG. 4 is a diagram illustrating an example of a hardware configuration of a communication terminal according to the first embodiment;

FIG. 5 is a diagram illustrating an example of a hardware configuration of an information processing apparatus and a personal computer (PC) according to the first embodiment;

FIG. 6 is a diagram illustrating an example of a hardware configuration of a user management server, an event management server, a virtual reality hybrid event management server, and a metaverse management server according to the first embodiment;

FIG. 7A is a diagram illustrating an example of a functional configuration of the information processing system according to the first embodiment;

FIG. 7B is a diagram illustrating an example of the functional configuration of the information processing system according to the first embodiment;

FIG. 7C is a diagram illustrating an example of the functional configuration of the information processing system according to the first embodiment;

FIG. 8 is an illustration of an example of a user management table according to the first embodiment;

FIG. 9 is an illustration of an example of an event management table according to the first embodiment;

FIG. 10 is an illustration of an example of an event user management table according to the first embodiment;

FIG. 11 is an illustration of an example of a held event management table according to the first embodiment;

FIG. 12 is an illustration of an example of a hybrid event management table according to the first embodiment;

FIG. 13 is a diagram illustrating an example of an event schedule registration screen according to the first embodiment;

FIG. 14 is a sequence diagram illustrating an example of a process including display processing of a device-associated-event list according to the first embodiment;

FIG. 15 is a diagram illustrating an example of a display screen of a device-associated-event list according to the first embodiment;

FIG. 16 is a sequence diagram illustrating an example of a process including display processing of a user-associated-event list according to the first embodiment;

FIG. 17 is a diagram illustrating an example of a display screen of a user-associated-event list according to the first embodiment;

FIG. 18 is a sequence diagram illustrating an example of processing of participating in an event from the communication terminal according to the first embodiment;

FIG. 19 is a diagram illustrating an example of a password information input screen according to the first embodiment;

FIG. 20 is a sequence diagram illustrating an example of a process including display processing of a metaverse-associated-event list according to the first embodiment;

FIG. 21 is a diagram illustrating an example of a display screen of a metaverse-associated-event list according to the first embodiment;

FIG. 22 is a sequence diagram illustrating an example of a process including display processing of a user-associated-event list according to the first embodiment;

FIG. 23A is a sequence diagram illustrating an example of a process including event participation coordination processing between the communication terminal and the metaverse according to the first embodiment;

FIG. 23B is a sequence diagram illustrating another example of the process including the event participation coordination processing between the communication terminal and the metaverse according to the first embodiment;

FIG. 23C is a sequence diagram illustrating another example of the process including the event participation coordination processing between the communication terminal and the metaverse according to the first embodiment;

FIG. 23D is a sequence diagram illustrating another example of the process including the event participation coordination processing between the communication terminal and the metaverse according to the first embodiment;

FIG. 23E is a sequence diagram illustrating another example of the process including the event participation coordination processing between the communication terminal and the metaverse according to the first embodiment;

FIG. 24 is a diagram illustrating an example screen of an event participation dialog according to the first embodiment;

FIG. 25A is a sequence diagram illustrating an example of a process including event participation coordination processing from the metaverse according to the first embodiment;

FIG. 25B is a sequence diagram illustrating another example of the process including the event participation coordination processing from the metaverse according to the first embodiment;

FIG. 25C is a sequence diagram illustrating another example of the process including the event participation coordination processing from the metaverse according to the first embodiment;

FIG. 25D is a sequence diagram illustrating another example of the process including the event participation coordination processing from the metaverse according to the first embodiment;

FIG. 26 is a diagram illustrating an example of a request input dialog according to the first embodiment;

FIG. 27 is a diagram illustrating an example of a request approval waiting dialog according to the first embodiment;

FIG. 28 is a diagram illustrating an example of a request notification dialog according to the first embodiment;

FIG. 29 is a flowchart illustrating an example of metaverse use processing according to the first embodiment;

FIG. 30 is a diagram illustrating an example of a screen displayed when the communication terminal participates in a virtual reality hybrid event according to the first embodiment;

FIG. 31 is a diagram illustrating an example of a screen displayed when users participate in a virtual reality hybrid event according to the first embodiment;

FIG. 32 is a sequence diagram illustrating an example of a process including processing of making a request to leave a meeting room in the metaverse according to the first embodiment;

FIG. 33 is a diagram illustrating an example of a display screen of a leave icon in an overhead view of the virtual space (metaverse) according to the first embodiment;

FIG. 34 is a diagram illustrating an example of a display screen of a waiting message according to the first embodiment;

FIG. 35 is a diagram illustrating an example of a general arrangement of an information processing system according to a second embodiment of the present disclosure;

FIG. 36 is a diagram illustrating an example of a three-dimensional metaverse screen displayed on virtual reality (VR) goggles according to the second embodiment; and

FIG. 37 is a diagram illustrating an example of a three-dimensional metaverse screen displayed on VR goggles according to a modification of the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure will be described below with reference to the drawings. In the description given with reference to the drawings, like reference signs denote like elements, and overlapping description is omitted.

### First Embodiment

### General Arrangement of Information Processing System

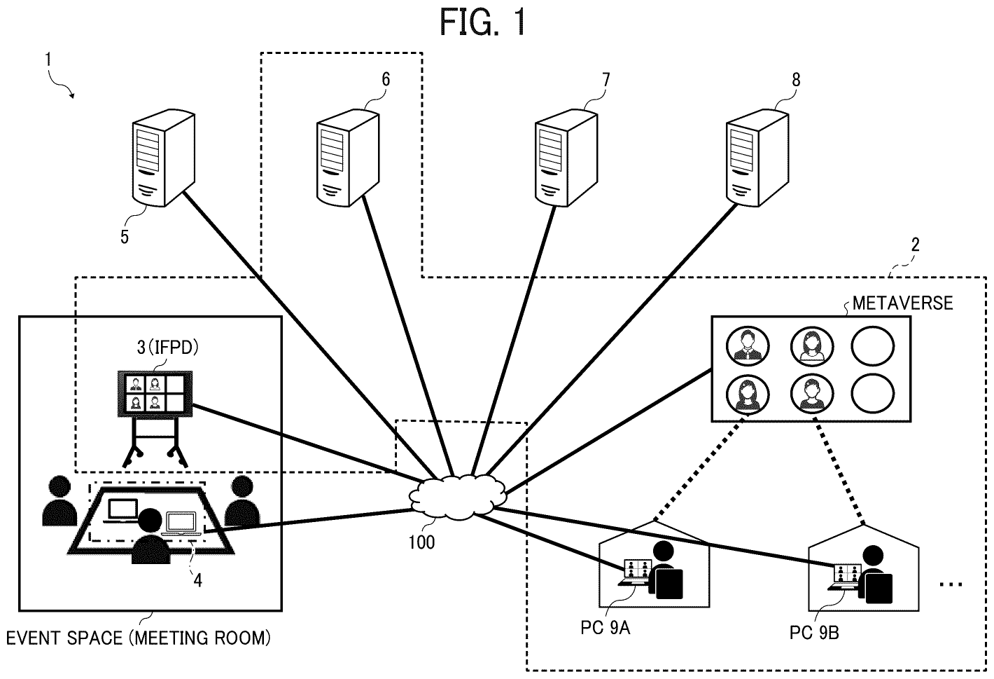

FIG. 1 is a diagram illustrating an example of a general arrangement of an information processing system. As illustrated in FIG. 1, an information processing system 1 includes a communication terminal 3 (an example of a first communication terminal), an information processing apparatus 4, and one or more personal computers (PCs) 9 (each being an example of a second communication terminal). The information processing system 1 also includes a user management server 5 (an example of a user management apparatus), an event management server 6 (an example of an event management apparatus), a virtual reality hybrid event management server 7 (an example of a virtual reality hybrid event management apparatus), and a metaverse management server 8 (an example of a metaverse management apparatus). The information processing system 1 further includes an event management system 2 that includes the communication terminal 3, the event management server 6, and the PCs 9. In the information processing system 1, the aforementioned apparatuses, a metaverse, and the aforementioned servers are connected to one another via a communication network 100.

The communication network 100 is a wired or wireless communication network via which an unspecified number of communications are performed. The communication network 100 is implemented by Internet, an intranet, a local area network (LAN), or the like. The communication network 100 may include a wireless communication network in compliance with the 4th generation (4G), the 5th generation (5G), Worldwide Interoperability for Microwave Access (WiMAX), Long Term Evolution (LTE), or the like. The communication terminal 3 and each of the servers may be connected to each other via a dedicated internal network or the like.

### Communication Terminal

The communication terminal 3 is a communication terminal located in a physical space and to be used for executing a predetermined event. The communication terminal 3 is, for example, a generally known interactive flat-panel display (IFPD), and is used in an event such as a meeting by one or more users that use the information processing system 1 (the event management system 2).

The communication terminal 3 is implemented by an information processing apparatus (computer system) that has a general-purpose operating system (OS) installed thereon and performs communication. The communication terminal 3 is one of the components of the information processing system 1. The communication terminal 3 can store, in a storage unit, a communication application installed thereon for communication with each of the servers and the PCs 9 via the communication network 100. The communication terminal 3 can also run browser software and software of various applications.

In the present embodiment, the communication terminal 3 functions as a first communication terminal.

### Information Processing Apparatus

The information processing apparatus 4 is an apparatus (communication terminal) used by a user that participates in a predetermined event. The information processing apparatus 4 is implemented by an information processing terminal (computer system) that has a general-purpose OS installed thereon and performs communication. The information processing apparatus 4 is one of the components of the information processing system 1. The information processing apparatus 4 can store, in a storage unit, a communication application or like installed thereon for communication with the communication terminal 3 and the like. The information processing apparatus 4 can also run browser software and software of various applications.

The information processing apparatus 4 may be a communication terminal having a communication function such as a general-purpose PC, a portable laptop PC, a mobile phone, a smartphone, a tablet terminal, or a (sunglass or wristwatch) wearable terminal.

### User Management Server

The user management server 5 is a server (apparatus) that manages user information. The user management server 5 is implemented by an information processing terminal (computer system) that has a general-purpose OS installed thereon and performs communication. The user management server 5 is one of the components of the information processing system 1. The user management server 5 can store, in a storage unit, a communication application or like installed thereon for communication with the communication terminal 3 and each of the servers. The user management server 5 can also run browser software and software of various applications.

The user management server 5 manages user information such as a user type, a user name, and an email address of a user. The user management server 5 has a user authentication function.

The user management server 5 may be a communication terminal having a communication function such as a general-purpose PC, a portable laptop PC, a mobile phone, a smartphone, or a tablet terminal.

The user management server 5 may notify another communication terminal or the like connected thereto via the communication network 100 of data (information) by push notification (transmit the data (information) by push transmission). In such a case, for example, the user management server 5 may perform push notification via Firebase Cloud Messaging (FCM) that is an example of a push notification server.

### Event Management Server

The event management server 6 is a server (apparatus) that manages information related to a predetermined event when the predetermined event is executed using the communication terminal 3 (first communication terminal) and the PC 9 (second communication terminal). The event management server 6 is implemented by an information processing terminal (computer system) that has a general-purpose OS installed thereon and performs communication. The event management server 6 is one of the components of the information processing system 1. The event management server 6 can store, in a storage unit, a communication application or like installed thereon for communication with the communication terminal 3, the PCs 9, and each of the servers. The event management server 6 can also run browser software and software of various applications.

The event management server 6 manages meeting information such as a host, a title, a time, a password, and a Uniform Resource Locator (URL) of a meeting. The event management server 6 manages, as a meeting user management table, participants of the meeting based on a user management table in association with each meeting. The event management server 6 also manages a participation state of each meeting along with information on a user and a participation time.

The event management server 6 may be a communication terminal having a communication function such as a general-purpose PC, a portable laptop PC, a mobile phone, a smartphone, or a tablet terminal.

The event management server 6 may notify another communication terminal or the like connected thereto via the communication network 100 of data (information) by push notification (transmit the data (information) by push transmission). In such a case, for example, the event management server 6 may perform push notification via FCM that is an example of a push notification server.

### Virtual Reality Hybrid Event Management Server

The virtual reality hybrid event management server 7 is a server (apparatus) that has a URL with which an event is executed between the apparatuses and the terminals connected to one another via the communication network 100 and allows users that access the URL to execute an event such as a video meeting. The virtual reality hybrid event management server 7 is implemented by an information processing terminal (computer system) that has a general-purpose OS installed thereon and performs communication. The virtual reality hybrid event management server 7 is one of the components of the information processing system 1. The virtual reality hybrid event management server 7 can store, in a storage unit, a communication application or like installed thereon for communication with the communication terminal 3, the PCs 9, and each of the servers. The virtual reality hybrid event management server 7 can also run browser software and software of various applications.

The virtual reality hybrid event management server 7 is, for example, a server that has a URL with which a meeting is executed between the terminals connected to one another via the communication network 100 and allows users that access the URL to execute a video meeting or the like.

The virtual reality hybrid event management server 7 may be a communication terminal having a communication function such as a general-purpose PC, a portable laptop PC, a mobile phone, a smartphone, or a tablet terminal.

The virtual reality hybrid event management server 7 may notify another communication terminal or the like connected thereto via the communication network 100 of data (information) by push notification (transmit the data (information) by push transmission). In such a case, for example, the virtual reality hybrid event management server 7 may perform push notification via FCM that is an example of a push notification server.

### Metaverse Management Server

The metaverse management server 8 is a server (apparatus) that has a URL with which an event is executed between the apparatuses and the terminals connected to one another via the communication network 100 and can provide users that access the URL with a video meeting or a broader virtual space. The metaverse management server 8 is implemented by an information processing terminal (computer system) that has a general-purpose OS installed thereon and performs communication. The metaverse management server 8 is one of the components of the information processing system 1. The metaverse management server 8 can store, in a storage unit, a communication application or like installed thereon for communication with the communication terminal 3, the PCs 9, and each of the servers. The metaverse management server 8 can also run browser software and software of various applications.

The metaverse management server 8 provides a metaverse space which users can participate in via a browser or the like.

The metaverse management server 8 may be a communication terminal having a communication function such as a general-purpose PC, a portable laptop PC, a mobile phone, a smartphone, or a tablet terminal.

The metaverse management server 8 may notify another communication terminal or the like connected thereto via the communication network 100 of data (information) by push notification (transmit the data (information) by push transmission). In such a case, for example, the metaverse management server 8 may perform push notification via FCM that is an example of a push notification server.

In the present embodiment, the above-described servers may be present as separate servers or a single server having a combination of the functions of the above-described servers. Each of the servers may use a meeting reservation system, an online meeting system, or the like which is prepared as general-purpose groupware.

### PC

The PC 9 is a communication terminal to be used to execute a predetermined event via a virtual space. The PC 9 is implemented by an information processing terminal (computer system) that has a general-purpose OS installed thereon and performs communication. The PC 9 is one of the components of the information processing system 1 (the event management system 2). The PC 9 can store, in a storage unit, a communication application or like installed thereon for communication with the communication terminal 3, the information processing apparatus 4, and each of the servers. The PC 9 can also run browser software and software of various applications.

The PC 9 may be a communication terminal having a communication function such as a general-purpose PC, a portable laptop PC, a mobile phone, a smartphone, a tablet terminal, or a (sunglass or wristwatch) wearable terminal.

In the present embodiment, the PC 9 functions as a second communication terminal.

As described above, in the information processing system 1, an IFPD is installed in a meeting room in the physical space, and a user in the meeting room can participate in a virtual reality hybrid event using the IFPD. On the other hand, a user at home or the like enters a metaverse, which is a virtual space, via a browser or the like, and participates in the virtual reality hybrid event using a meeting room in the metaverse.

### Terms

In the present embodiment, the term “user” refers to a person who uses or utilizes the information processing system 1 (the event management system 2). The term “user” also refers to a participant who participates in a predetermined event. In the present embodiment, the term “user” further refers to a meeting room (IFPD) at an office or the like, a meeting room in a metaverse, or the like.

In the present embodiment, the term “event” refers to a target that is executed, such as a conference, a meeting, a lecture, and a class to be carried out face-to-face in a physical space and online using a virtual space. Based on this definition, in the present embodiment, the term “predetermined event” refers to the same kind of target that is executed, including a conference, a meeting, a lecture, and a class to be executed in the physical space and the virtual space in the same time slot. The term “virtual reality hybrid event” refers to an event that is implemented as a result of an event such as a meeting that is carried out using a meeting room in the physical space being simultaneously carried out online using the virtual space.

### Layout Example of Physical Space (Event Space)

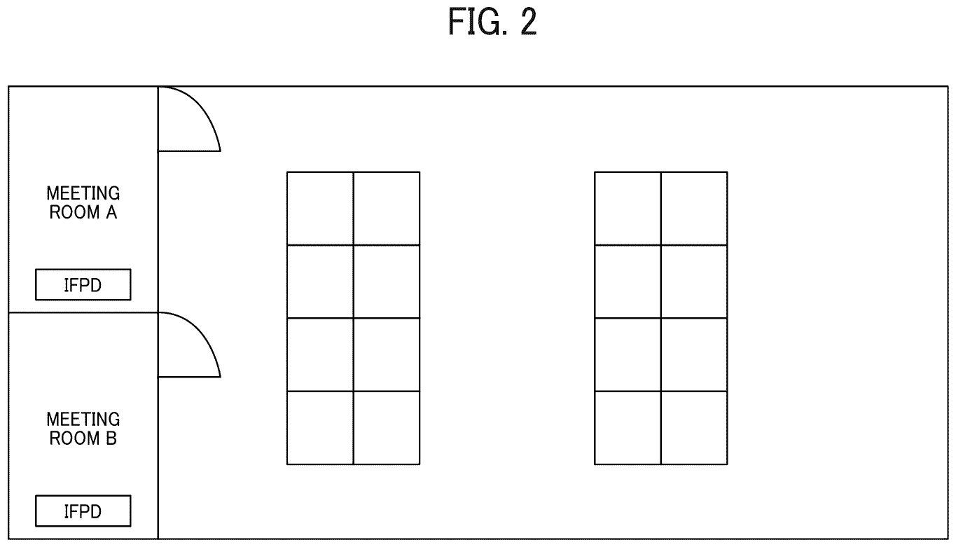

FIG. 2 is an overhead view of an example of a physical space (event space) according to the embodiment. An IFPD located in the physical space is, for example, basically an electronic whiteboard, and includes an online meeting system as well as an electronic whiteboard function. In such an environment, the IFPD is used in a meeting that is carried out just in a meeting room, a meeting of hybrid work, or the like.

### Layout Example of Virtual Space (Metaverse)

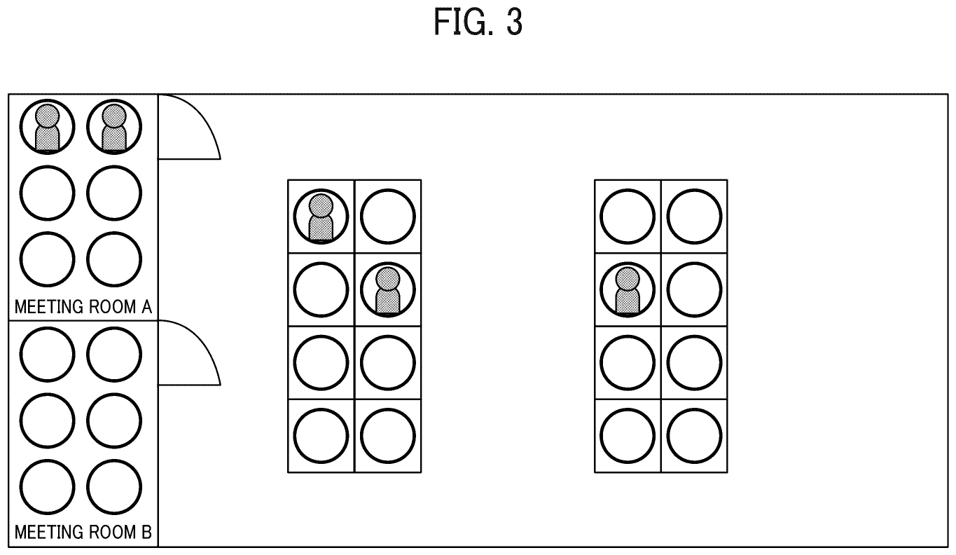

FIG. 3 is an overhead view of an example of a virtual space (metaverse) according to the embodiment. A metaverse, which is intended to make communication more active, is utilized in recent remote work. Some services allow connection to an online meeting system from the metaverse. A service for customizing the metaverse space is also provided, and allows the space to be designed to resemble the real office. In the metaverse space, users move their avatars (e.g., circles each including a person icon or person icons in respective circles) to head for their destination(s), have seats, or enter a meeting room. The metaverse has a function that allows, in response to users entering a meeting room using their avatars, members in that meeting room to have an ad hoc online meeting.

### Hardware Configurations

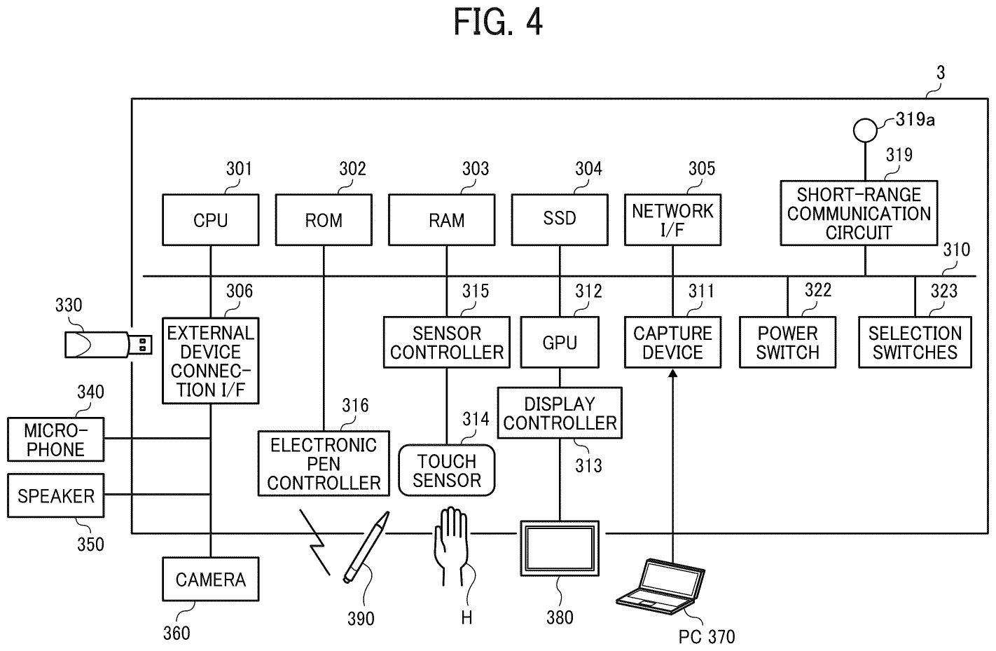

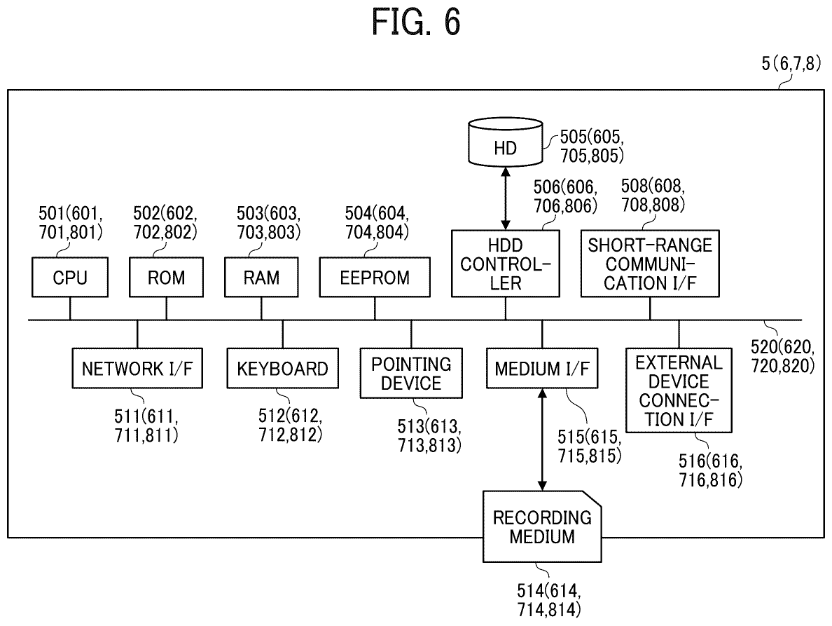

Hardware configurations of the devices or apparatuses of the information processing system 1 according to the embodiment will be described next with reference to FIGS. 4 to 6. Note that a certain element may be added to or deleted from the hardware configuration of the communication terminal or the apparatus illustrated in FIGS. 4 and 6 as appropriate.

### Hardware Configuration of Communication Terminal

FIG. 4 is a diagram illustrating an example of a hardware configuration of the communication terminal according to the embodiment. As illustrated in FIG. 4, the communication terminal 3 (e.g., an IFPD (electronic whiteboard)) is implemented by, for example, a computer, and includes a central processing unit (CPU) 301, a read-only memory (ROM) 302, a random access memory (RAM) 303, a solid state drive (SSD) 304, a network interface (I/F) 305, an external device connection IF 306, and a bus line 310.

The CPU 301 controls operations of the entire communication terminal 3. The ROM 302 stores an initial program loader (IPL) or any other program to drive the CPU 301. The RAM 303 is used as a work area for the CPU 301.

The SSD 304 stores various kinds of data such as a program for the communication terminal 3. The network I/F 305 controls communication via the communication network 100. The external device connection I/F 306 is an interface for connecting various external devices. The external devices in this case include a Universal Serial Bus (USB) memory 330 and externally attached devices such as a microphone 340, a speaker 350, and a camera 360.

The communication terminal 3 further includes a capture device 311, a graphics processing unit (GPU) 312, a display controller 313, a touch sensor 314, a sensor controller 315, an electronic pen controller 316, a short-range communication circuit 319, an antenna 319a for the short-range communication circuit 319, a power switch 322, and selection switches 323.

The capture device 311 acquires video data displayed on the display of the external PC 370 and displays the video data as a still image or a moving image. The GPU 312 is a semiconductor chip dedicated to graphics. The display controller 313 controls and manages screen display to output an image from the GPU 312 to a display 380. The touch sensor 314 detects a touch of an electronic pen 390 or a hand H of a user on the display 380. The sensor controller 315 controls processing of the touch sensor 314. The touch sensor 314 inputs and detects the coordinates according to an infrared interruption system. This method of inputting and detecting the coordinates is as follows. The display 380 is provided with two light receiving and emitting devices at respective upper ends thereof and is surrounded by a reflector. The light receiving and emitting devices emit a plurality of infrared beams in parallel to a surface of the display 380. The reflector reflects the plurality of infrared beams. The reflected infrared beams return along the same optical path as the emitted infrared beams. Light receiving elements receive the returning beams. The touch sensor 314 outputs, to the sensor controller 315, an identifier (ID) of an infrared beam that is emitted from the two light receiving and emitting devices and is then interrupted by an object. The sensor controller 315 identifies the coordinates of the position touched by the object. The electronic pen controller 316 communicates with the electronic pen 390 to detect a touch of a tip or bottom of the electronic pen 390 on the display 380. The short-range communication circuit 319 is a communication circuit of Near Field Communication (NFC), Bluetooth®, or the like. The power switch 322 is a switch for powering the communication terminal 3 ON and OFF. The selection switches 323 are, for example, a group of switches for adjusting the brightness and hue of display on the display 380.

The communication terminal 3 includes the bus line 310. The bus line 310 is a bus such as an address bus or a data bus, which electrically connects the components such as the CPU 301 illustrated in FIG. 4 to one another.

The touch sensor 314 is not limited to that of the infrared interruption system. As the touch sensor 314, a detector such as a capacitive touch panel that identifies a touched position by detecting a change in capacitance, a resistive film touch panel that identifies a touched position by detecting a change in voltage across two opposed resistive films, or an electromagnetic induction touch panel that identifies a touched position by detecting electromagnetic induction caused by a contact of an object onto the display may be used. The electronic pen controller 316 may detect a touch of a part of the electronic pen 390 held by a user or another part of the electronic pen 390 as well as a touch of the tip or bottom of the electronic pen 390.

### Hardware Configuration of Information Processing Apparatus and PC

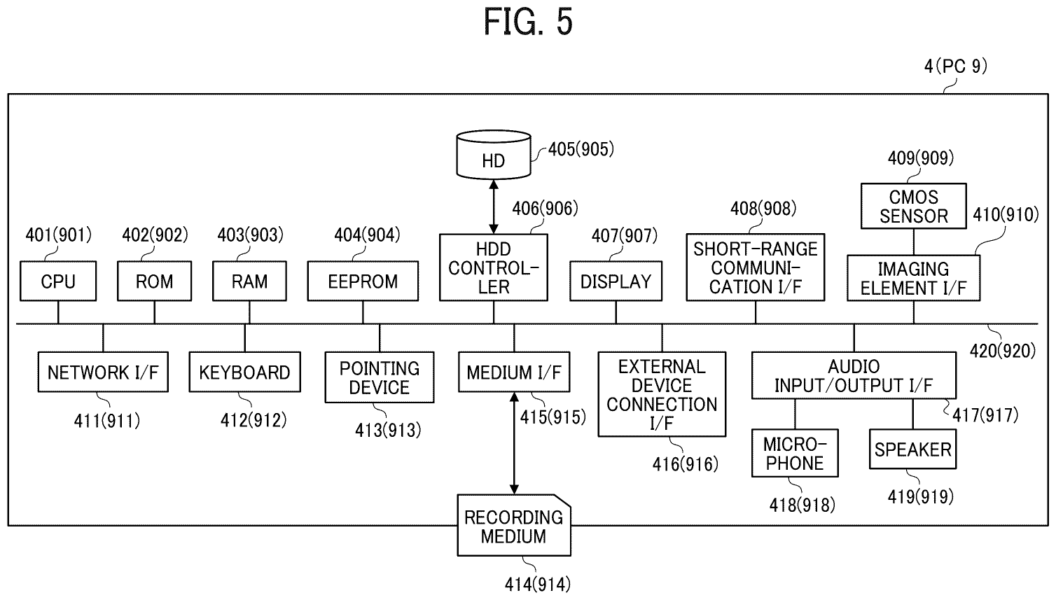

FIG. 5 is a diagram illustrating an example of a hardware configuration of the information processing apparatus and the PC according to the embodiment. As illustrated in FIG. 5, the information processing apparatus 4 is implemented by, for example, a computer, and includes a CPU 401, a ROM 402, a RAM 403, an electrically erasable programmable ROM (EEPROM) 404, a hard disk (HD) 405, a hard disk drive (HDD) controller 406, a display 407, a short-range communication I/F 408, a complementary metal oxide semiconductor (CMOS) sensor 409, and an imaging element I/F 410. The information processing apparatus 4 further includes a network I/F 411, a keyboard 412, a pointing device 413, a medium I/F 415, an external device connection I/F 416, an audio input/output I/F 417, a microphone 418, a speaker 419, and a bus line 420.

The CPU 401 controls operations of the entire information processing apparatus 4. The ROM 402 stores, for example, a program to drive the CPU 401. The RAM 403 is used as a work area for the CPU 401. The EEPROM 404 reads or writes various kinds of data such as an application under control of the CPU 401. The HD 405 stores various kinds of data such as a program. The HDD controller 406 controls reading or writing of various kinds of data from or to the HD 405 under control of the CPU 401. The information processing apparatus 4 may include an SSD instead of the HD 405 and the HDD controller 406. The display 407 displays various kinds of information such as a cursor, a menu, a window, characters, or an image. In the present embodiment, the display 407 functions as an example of a display. The short-range communication I/F 408 is a communication circuit for performing data communication with a communication device, a communication terminal, or the like including a wireless communication interface of NFC, Bluetooth® (® is omitted below), Wi-Fi® (® is omitted below), or the like. The CMOS sensor 409 is a type of a built-in imaging device that images a subject to obtain image data or video data under control of the CPU 401. The imaging device may be an imaging device including a charge coupled device (CCD) sensor in place of the CMOS sensor. The imaging element I/F 410 is a circuit that controls driving of the CMOS sensor 409.

The network I/F 411 is an interface for performing data communication using the communication network 100. The keyboard 412 is a type of an input device including a plurality of keys with which characters, numerical values, various instructions, and the like are input. Instead of or in addition to the keyboard 412, an input device such as a touch panel for operating predetermined buttons or icons may be used. The pointing device 413 is a type of an input device with which various instructions are selected or executed, a processing target is selected, or a cursor is moved. The medium I/F 415 controls reading or writing (storing) of data from or to a recording medium 414 such as a flash memory. The external device connection I/F 416 is an interface for connecting various external devices. The external devices in this case may include, for example, a USB memory. The audio input/output I/F 417 is a circuit that processes inputting and outputting of an audio signal from the microphone 418 and to the speaker 419 under control of the CPU 401. The microphone 418 is a built-in circuit that converts sound into an electric signal, and acquires voice and a sound wave to be emitted from an external speaker or the like to acquire information using the electric signal. The speaker 419 is a built-in circuit that converts an electric signal into physical vibration to produce sound such as music or voice. The bus line 420 is a bus such as an address bus or a data bus, which electrically connects the components such as the CPU 401 to one another.

The PC 9 is implemented by, for example, a computer, and includes a CPU 901, a ROM 902, a RAM 903, an EEPROM 904, an HD 905, an HDD controller 906, a display 907, a short-range communication I/F 908, a CMOS sensor 909, and an imaging element I/F 910. The PC 9 further includes a network I/F 911, a keyboard 912, a pointing device 913, a medium I/F 915, an external device connection I/F 916, an audio input/output I/F 917, a microphone 918, a speaker 919, and a bus line 920. Description of these hardware resources is omitted because these hardware resources are substantially the same as the CPU 401, the ROM 402, the RAM 403, the EEPROM 404, the HD 405, the HDD controller 406, the display 407, the short-range communication I/F 408, the CMOS sensor 409, the imaging element I/F 410, the network I/F 411, the keyboard 412, the pointing device 413, the medium I/F 415, the external device connection I/F 416, the audio input/output I/F 417, the microphone 418, the speaker 419, and the bus line 420 of the information processing apparatus 4.

### Hardware Configuration of Various Servers

FIG. 6 is a diagram illustrating an example of a hardware configuration of the user management server, the event management server, the virtual reality hybrid event management server, and the metaverse management server according to the embodiment. As illustrated in FIG. 6, the user management server 5 is implemented by, for example, a computer, and includes a CPU 501, a ROM 502, a RAM 503, an EEPROM 504, an HD 505, an HDD controller 506, and a short-range communication I/F 508. The user management server 5 further includes a network I/F 511, a keyboard 512, a pointing device 513, a medium I/F 515, an external device connection I/F 516, and a bus line 520.

The CPU 501 controls operations of the entire user management server 5. The ROM 502 stores, for example, a program to drive the CPU 501. The RAM 503 is used as a work area for the CPU 501. The EEPROM 504 reads or writes various kinds of data such as an application under control of the CPU 501. The HD 505 stores various kinds of data such as a program. The HDD controller 506 controls reading or writing of various kinds of data from or to the HD 505 under control of the CPU 501. The user management server 5 may include an SSD instead of the HD 505 and the HDD controller 506. The short-range communication I/F 508 is a communication circuit for performing data communication with a communication device, a communication terminal, or the like including a wireless communication interface of NFC, Bluetooth, Wi-Fi, or the like.

The network I/F 511 is an interface for performing data communication using the communication network 100. The keyboard 512 is a type of an input device including a plurality of keys with which characters, numerical values, various instructions, and the like are input. Instead of or in addition to the keyboard 512, an input device such as a touch panel for operating predetermined buttons or icons may be used. The pointing device 513 is an example of an input device with which various instructions are selected or executed, a processing target is selected, or a cursor is moved. The medium I/F 515 controls reading or writing (storing) of data from or to a recording medium 514 such as a flash memory. The external device connection I/F 516 is an interface for connecting various external devices. The external devices in this case may include, for example, a USB memory. The bus line 520 is a bus such as an address bus or a data bus, which electrically connects the components such as the CPU 501 to one another.

The event management server 6 is implemented by, for example, a computer and includes hardware resources that are denoted by reference signs in 600s and are substantially the same as the respective hardware resources that are denoted by reference signs in 500s and are described in relation to the user management server 5. Thus, description of the hardware resources of the event management server 6 is omitted.

The virtual reality hybrid event management server 7 is implemented by, for example, a computer and includes hardware resources that are denoted by reference signs in 700s and are substantially the same as the respective hardware resources that are denoted by reference signs in 500s and are described in relation to the user management server 5. Thus, description of the hardware resources of the virtual reality hybrid event management server 7 is omitted.

The metaverse management server 8 is implemented by, for example, a computer and includes hardware resources that are denoted by reference signs in 800s and are substantially the same as the respective hardware resources that are denoted by reference signs in 500s and are described in relation to the user management server 5. Thus, description of the hardware resources of the metaverse management server 8 is omitted.

For example, the above-described programs may be recorded in an installable or executable file format on a computer-readable recording medium for distribution, or may be downloaded via a network for distribution. Examples of the recording medium include a compact disc-recordable (CD-R), a digital versatile disc (DVD), and a Blu-ray® (® is omitted below) Disc, a secure digital (SD) card, and a USB memory. Such a recording medium may be provided in the form of a program product domestically or internationally. For example, the event management server 6 executes a program according to an embodiment of the present disclosure to implement an event management method according to an embodiment of the present disclosure.

### Functional Configuration of Information Processing System

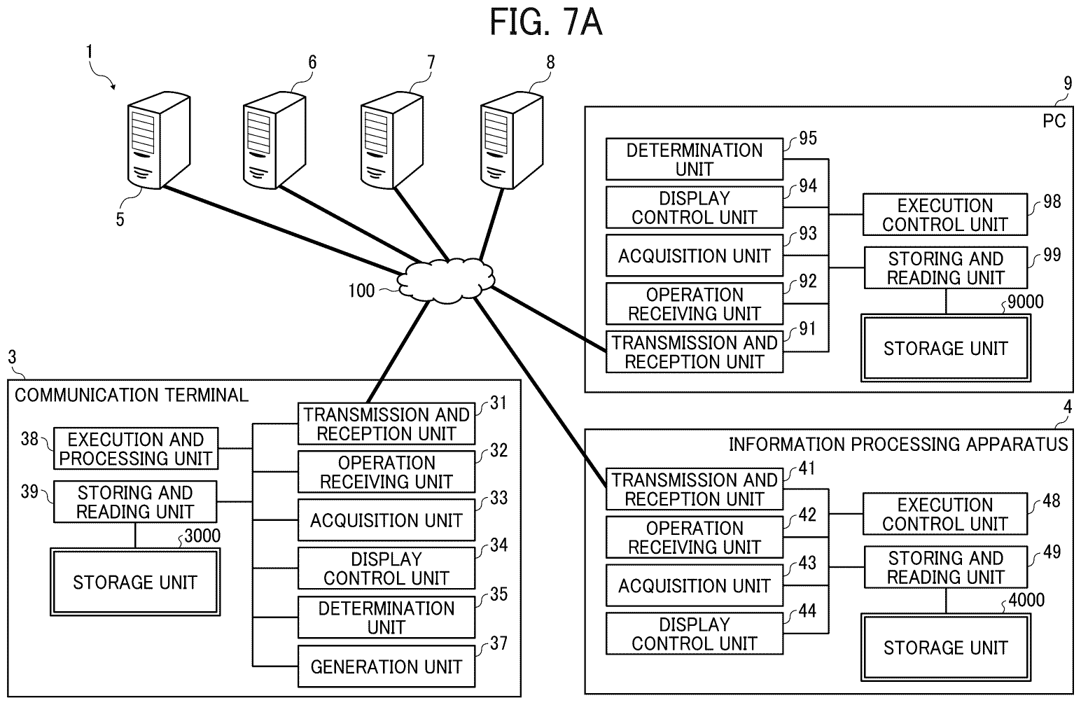

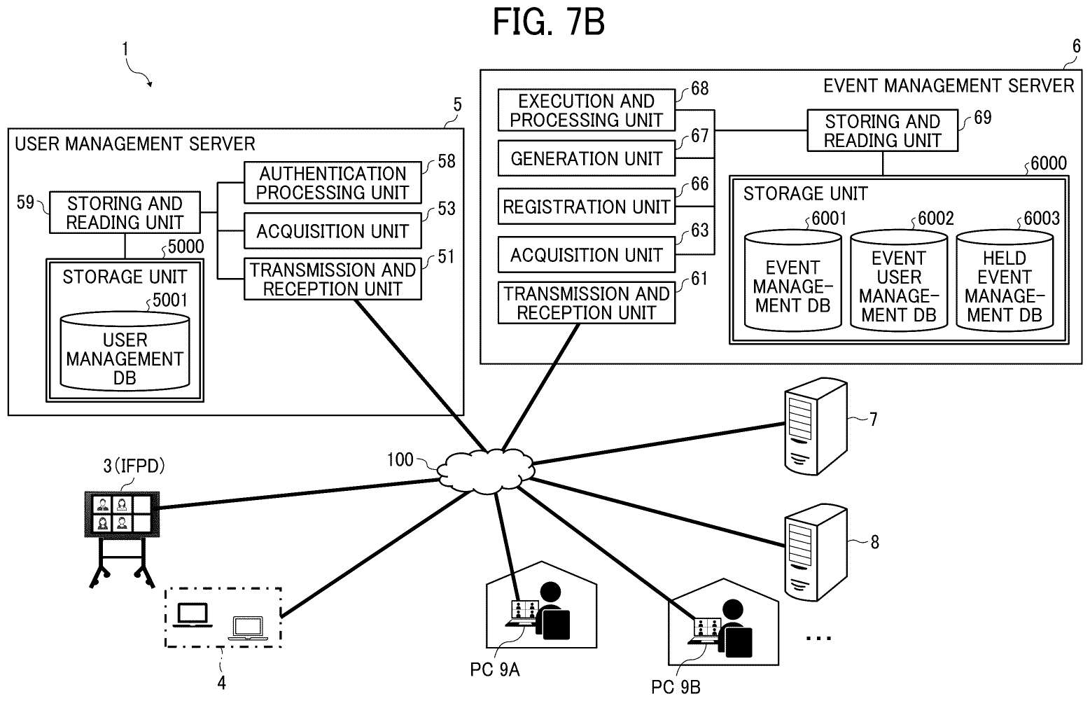

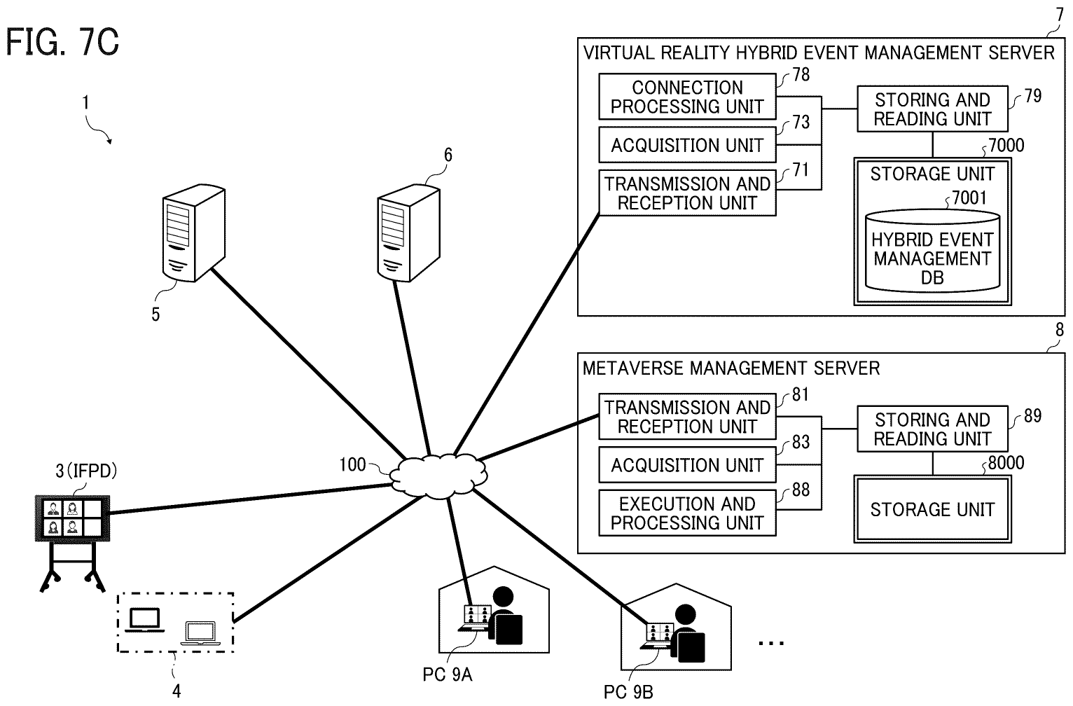

A functional configuration of the information processing system according to the present embodiment will be described next with reference to FIGS. 7A, 7B, and 7C to FIG. 12. FIGS. 7A, 7B, and 7C are diagrams illustrating an example of a functional configuration of the information processing system according to the embodiment. Note that FIGS. 7A, 7B, and 7C illustrate components related to processing or operations described below among the components of the communication terminals or apparatuses (servers) illustrated in FIG. 1.

### Functional Configuration of Communication Terminal

A functional configuration of the communication terminal 3 will be described first with reference to FIG. 7A. As illustrated in FIG. 7A, the communication terminal 3 includes a transmission and reception unit 31, an operation receiving unit 32, an acquisition unit 33, a display control unit 34, an execution and processing unit 38, and a storing and reading unit 39. Each of these functional units is a function or unit implemented by one or more of the hardware resources illustrated in FIG. 4 operating in response to an instruction from the CPU 301 according to a program for the communication terminal 3 loaded into the RAM 303 from at least one of the ROM 302, the SSD 304, and the USB memory 330. The communication terminal 3 includes a storage unit 3000 (an example of a storage unit) implemented by at least one of the ROM 302, the SSD 304, and the USB memory 330 illustrated in FIG. 4. In the storage unit 3000, a communication program (communication application) for communicating with the user management server 5, the event management server 6, and the like via the communication network 100 is installed and stored.

### Each Functional Unit of Communication Terminal

Each functional unit of the communication terminal 3 will be described in detail next. The transmission and reception unit 31 of the communication terminal 3 illustrated in FIG. 7A is mainly implemented by processing of the CPU 301 on the network I/F 305 and the short-range communication circuit 319. The transmission and reception unit 31 transmits and receives various kinds of data (information) to and from the user management server 5, the event management server 6, and the like via the communication network 100. The transmission and reception unit 31 receives an event participation notification transmitted by the event management server 6. In the present embodiment, the transmission and reception unit 31 functions as an example of at least one of a transmission unit and a reception unit.

The operation receiving unit 32 is mainly implemented by the CPU 301 processing signals generated in response to various operations received by at least one of the power switch 322, the selection switches 323, and the display 380. The operation receiving unit 32 receives an operation on the communication terminal 3. In the present embodiment, the operation receiving unit 32 functions as an example of a receiving unit.

The acquisition unit 33 is mainly implemented by processing of the CPU 301. The acquisition unit 33 acquires various kinds of information received by the transmission and reception unit 31. In the present embodiment, the acquisition unit 33 functions as an example of an acquisition unit.

The display control unit 34 is mainly implemented by processing of the CPU 301. The display control unit 34 controls display of various user interface (UI) screens on the communication terminal 3. The display control unit 34 causes the display 380 to display an event participation notification generated by the event management server 6. The display control unit 34 causes the display 380 to display, as the event participation notification, a dialog to be operated on the communication terminal 3 by a user who uses the communication terminal 3. In the present embodiment, the display control unit 34 functions as an example of a display control unit.

A determination unit 35 is mainly implemented by processing of the CPU 301. The determination unit 35 makes various determinations in the communication terminal 3. In the present embodiment, the determination unit 35 functions as an example of a determination unit.

A generation unit 37 is mainly implemented by processing of the CPU 301. The generation unit 37 generates various kinds of information (or data), UI screen data, and the like in the communication terminal 3. In the present embodiment, the generation unit 37 functions as an example of a generation unit.

The execution and processing unit 38 is mainly implemented by processing of the CPU 301. The execution and processing unit 38 executes various kinds of processing in the communication terminal 3. In the present embodiment, the execution and processing unit 38 functions as an example of an execution unit and a processing unit.

The storing and reading unit 39 is mainly implemented by processing of the CPU 301 on at least one of the ROM 302, the SSD 304, and the USB memory 330. The storing and reading unit 39 stores or reads various kinds of data (or information) to or from the storage unit 3000. In the present embodiment, the storing and reading unit 39 functions as an example of a storage control unit.

### Functional Configuration of Information Processing Apparatus

A functional configuration of the information processing apparatus 4 will be described next. As illustrated in FIG. 7A, the information processing apparatus 4 includes a transmission and reception unit 41, an operation receiving unit 42, an acquisition unit 43, a display control unit 44, an execution control unit 48, and a storing and reading unit 49. Each of these functional units is a function or unit implemented by one or more of the hardware resources illustrated in FIG. 5 operating in response to an instruction from the CPU 401 according to a program for the information processing apparatus 4 loaded into the RAM 403 from at least one of the ROM 402, the EEPROM 404, the HD 405, and the recording medium 414. The information processing apparatus 4 includes a storage unit 4000 (an example of a storage unit) implemented by at least one of the EEPROM 404, the HD 405, and the recording medium 414 illustrated in FIG. 5. In the storage unit 4000, a communication program (communication application) for communicating with the communication terminal 3, the user management server 5, the event management server 6, and the like via the communication network 100 is installed and stored.

### Each Functional Unit of Information Processing Apparatus

Each functional unit of the information processing apparatus 4 will be described in detail next. The transmission and reception unit 41 of the information processing apparatus 4 illustrated in FIG. 7A is mainly implemented by processing of the CPU 401 on the network I/F 411 and the short-range communication I/F 408. The transmission and reception unit 41 transmits and receives various kinds of data (information) to and from the communication terminal 3, the user management server 5, the event management server 6, and the like via the communication network 100. In the present embodiment, the transmission and reception unit 41 functions as an example of at least one of a transmission unit and a reception unit.

The operation receiving unit 42 is mainly implemented by the CPU 401 processing signals generated in response to various operations received by at least one of the keyboard 412 and the pointing device 413. The operation receiving unit 42 receives an operation on the information processing apparatus 4. In the present embodiment, the operation receiving unit 42 functions as an example of a receiving unit.

The acquisition unit 43 is mainly implemented by processing of the CPU 401. The acquisition unit 43 acquires various kinds of information received by the transmission and reception unit 41. In the present embodiment, the acquisition unit 43 functions as an example of an acquisition unit.

The display control unit 44 is mainly implemented by processing of the CPU 401 on the display 407. The display control unit 44 controls display of various UI screens on the information processing apparatus 4. In the present embodiment, the display control unit 34 functions as an example of a display control unit.

The execution control unit 48 is mainly implemented by processing of the CPU 401. The execution control unit 48 controls execution of various kinds of processing in the information processing apparatus 4. In the present embodiment, the execution control unit 48 functions as an example of an execution control unit.

The storing and reading unit 49 is mainly implemented by processing of the CPU 401 on at least one of the ROM 402, the EEPROM 404, the HD 405, and the recording medium 414. The storing and reading unit 49 stores or reads various kinds of data (or information) to or from the storage unit 4000. In the present embodiment, the storing and reading unit 49 functions as an example of a storage control unit.

### Functional Configuration of PC

A functional configuration of the PC 9 will be described next. As illustrated in FIG. 7A, the PC 9 includes a transmission and reception unit 91, an operation receiving unit 92, an acquisition unit 93, a display control unit 94, a determination unit 95, an execution control unit 98, and a storing and reading unit 99. Each of these functional units is a function or unit implemented by one or more of the hardware resources illustrated in FIG. 5 operating in response to an instruction from the CPU 901 according to a program for the PC 9 loaded into the RAM 903 from at least one of the ROM 902, the EEPROM 904, the HD 905, and a recording medium 914. The PC 9 further includes a storage unit 9000 (an example of a storage unit) which is implemented by at least one of the ROM 902, the EEPROM 904, the HD 905, and the recording medium 914 illustrated in FIG. 5. In the storage unit 9000, a communication program (communication application) for communicating with the communication terminal 3, the information processing apparatus 4, the user management server 5, the event management server 6, and the like via the communication network 100 is installed and stored.

### Each Functional Unit of PC

Each functional unit of the PC 9 will be described in detail next. The transmission and reception unit 91 of the PC 9 illustrated in FIG. 7A is mainly implemented by processing of the CPU 901 on the network I/F 911 and the short-range communication I/F 908. The transmission and reception unit 91 transmits and receives various kinds of data (information) to and from the communication terminal 3, the information processing apparatus 4, the user management server 5, the event management server 6, and the like via the communication network 100. The transmission and reception unit 91 receives an event participation notification transmitted from the event management server 6. In the present embodiment, the transmission and reception unit 91 functions as an example of at least one of a transmission unit and a reception unit.

The operation receiving unit 92 is mainly implemented by the CPU 901 processing signals generated in response to various operations received by at least one of the keyboard 912 and the pointing device 913. The operation receiving unit 92 receives an operation on the PC 9. In the present embodiment, the operation receiving unit 92 functions as an example of a receiving unit.

The acquisition unit 93 is mainly implemented by processing of the CPU 901. The acquisition unit 93 acquires various kinds of information received by the transmission and reception unit 91. In the present embodiment, the acquisition unit 93 functions as an example of an acquisition unit.

The display control unit 94 is mainly implemented by processing of the CPU 901 on the display 907. The display control unit 94 controls display of various UI screens on the PC 9. The display control unit 94 causes the display 907 to display an event participation notification generated by the event management server 6. In the present embodiment, the display control unit 94 functions as an example of a display control unit.

The execution control unit 98 is mainly implemented by processing of the CPU 901. The execution control unit 98 controls execution of various kinds of processing in the PC 9. In the present embodiment, the execution control unit 98 functions as an example of an execution control unit.

The storing and reading unit 99 is mainly implemented by processing of the CPU 901 on at least one of the ROM 902, the EEPROM 904, the HD 905, and the recording medium 914. The storing and reading unit 99 stores or reads various kinds of data (or information) to or from the storage unit 9000. In the present embodiment, the storing and reading unit 99 functions as an example of a storage control unit.

### Functional Configuration of User Management Server

A functional configuration of the user management server 5 will be described in detail next with reference to FIG. 7B. As illustrated in FIG. 7B, the user management server 5 includes a transmission and reception unit 51, an acquisition unit 53, an authentication processing unit 58, and a storing and reading unit 59. Each of these functional units is a function or unit implemented by one or more of the hardware resources illustrated in FIG. 6 operating in response to an instruction from the CPU 501 according to a program for the user management server 5 loaded into the RAM 503 from at least one of the ROM 502, the EEPROM 504, the HD 505, and the recording medium 514. The user management server 5 further includes a storage unit 5000 (an example of a storage unit) which is implemented by at least one of the ROM 502, the EEPROM 504, the HD 505, and the recording medium 514 illustrated in FIG. 6. In the storage unit 5000, a communication program (communication application) for communicating with the event management server 6 and the like via the communication network 100, a browser application, and the like are installed and stored.

### Each Functional Unit of User Management Server

Each functional unit of the user management server 5 will be described in detail next. The transmission and reception unit 51 of the user management server 5 illustrated in FIG. 7B is mainly implemented by processing of the CPU 501 on the network I/F 511 and the short-range communication I/F 508. The transmission and reception unit 51 transmits and receives various kinds of data (or information) to and from the communication terminal 3 and the PC 9 via the communication network 100. In the present embodiment, the transmission and reception unit 51 functions as an example of at least one of a transmission unit and a reception unit.

The acquisition unit 53 is mainly implemented by processing of the CPU 501. The acquisition unit 53 acquires, via the transmission and reception unit 51, a user ID and a password included in a user authentication request transmitted from the communication terminal 3 and the PC 9. In the present embodiment, the acquisition unit 53 functions as an example of an acquisition unit.

The authentication processing unit 58 is mainly implemented by processing of the CPU 501. The authentication processing unit 58 executes authentication processing in the user management server 5. In the present embodiment, the authentication processing unit 58 functions as an example of an authentication unit or an example of a processing unit.

The storing and reading unit 59 is mainly implemented by processing of the CPU 501 on at least one of the ROM 502, the EEPROM 504, the HD 505, and the recording medium 514. The storing and reading unit 59 stores or reads various kinds of data (or information) to or from the storage unit 5000. In the present embodiment, the storing and reading unit 59 functions as an example of a storage control unit.

### User Management Table

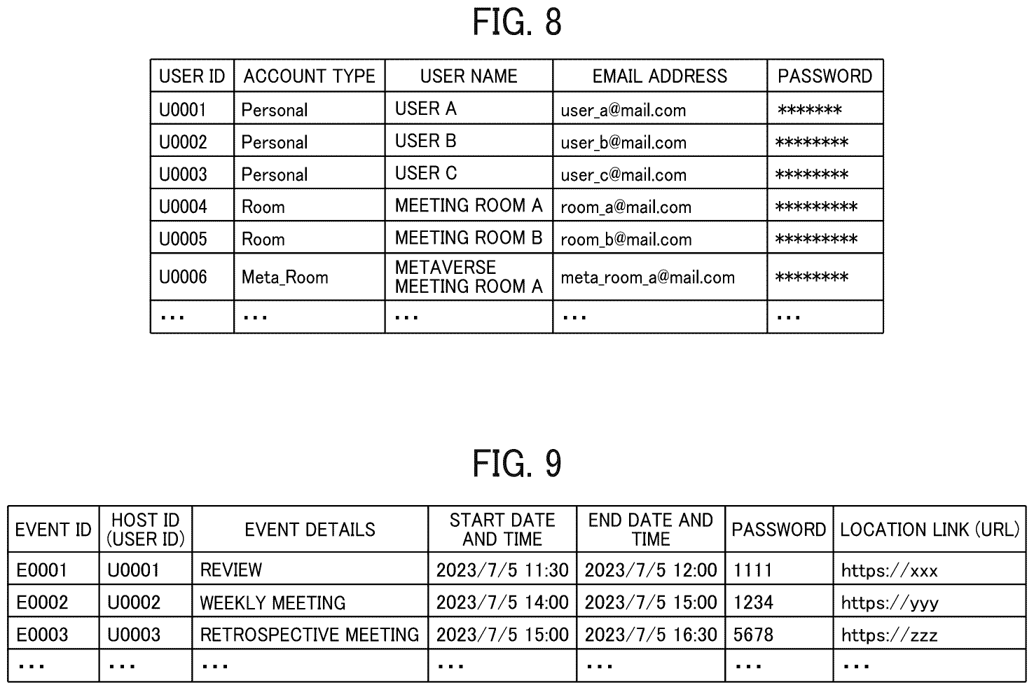

FIG. 8 is an illustration of an example of a user management table according to the embodiment. The structure and content of the data table described below are an example, and are not limited to this example. The storage unit 5000 includes a user management database (DB) 5001 implemented by the user management table illustrated in FIG. 8. The user management table stores and manages, for each user ID, an account type, a user name, an email address, and a password in association with one another.

The user ID is identification information for identifying a user that uses or utilizes the information processing system 1 (the event management system 2). The account type indicates a type of a participation entity that participates in a predetermined event. Examples of the participation entity include a person who is a user, a place such as a meeting room located in the physical space, and a metaverse (metaverse space) used as a virtual space. The user name indicates a name of the participation entity that participates in the predetermined event. The email address indicates an email address given in association with each user ID. The password is information that is given in association with the user name and includes alphabets and numerals for use in user authentication.

In the present embodiment, the user management table (the user management DB 5001) functions as an example of a user management unit.

### Functional Configuration of Event Management Server

Referring back to FIG. 7B, a functional configuration of the event management server 6 will be described. As illustrated in FIG. 7B, the event management server 6 includes a transmission and reception unit 61, an acquisition unit 63, a registration unit 66, a generation unit 67, an execution and processing unit 68, and a storing and reading unit 69. Each of these functional units is a function or unit implemented by one or more of the hardware resources illustrated in FIG. 6 operating in response to an instruction from the CPU 601 according to a program for the event management server 6 loaded into the RAM 603 from at least one of the ROM 602, the EEPROM 604, the HD 605, and the recording medium 614. The event management server 6 further includes a storage unit 6000 (an example of a storage unit) which is implemented by at least one of the ROM 602, the EEPROM 604, the HD 605, and the recording medium 614 illustrated in FIG. 6. In the storage unit 6000, a communication program (communication application) for communicating with the user management server 5 and the like via the communication network 100, a browser application, and the like are installed and stored.

### Each Functional Unit of Event Management Server

Each functional unit of the event management server 6 will be described in detail next. The transmission and reception unit 61 of the event management server 6 illustrated in FIG. 7B is mainly implemented by processing of the CPU 601 on the network I/F 611 and the short-range communication I/F 608. The transmission and reception unit 61 transmits and receives various kinds of data (or information) to and from the communication terminal 3, the user management server 5, and the like via the communication network 100. The transmission and reception unit 61 transmits an event participation notification generated by the generation unit 67 (described later), to another communication terminal that is scheduled to participate in but has not participated in a predetermined event. In the present embodiment, the transmission and reception unit 61 functions as an example of at least one of a transmission unit and a reception unit.

The acquisition unit 63 is mainly implemented by processing of the CPU 601. The acquisition unit 63 acquires various kinds of information (data) transmitted from the communication terminal 3, the PC 9, and the like and data in various databases managed by the event management server 6. In the present embodiment, the acquisition unit 63 functions as an example of an acquisition unit.

The registration unit 66 is mainly implemented by processing of the CPU 601. The registration unit 66 registers various kinds of information to the event management server 6. The registration unit 66 registers, to a held event management DB 6003 (see FIG. 11), a user ID (an example of user identification information) included in a participation request for a predetermined event (event participation request) transmitted by the communication terminal 3 in association with participation date and time information indicating a participation date and time of participation of a user corresponding to the user ID in the predetermined event. In the present embodiment, the registration unit 66 functions as an example of a registration unit.

The generation unit 67 is mainly implemented by processing of the CPU 601. After one communication terminal of the communication terminal 3 and the PC 9 performs processing of participating in a predetermined event, the generation unit 67 generates an event participation notification that prompts the other communication terminal that is scheduled to participate in but has not participated in the predetermined event to participate in the predetermined event. The generation unit 67 generates the event participation notification, based on a participation date and time of participation of the one communication terminal of the communication terminal 3 and the PC 9 in the predetermined event. The generation unit 67 generates, as the event participation notification, a notification including an event name representing the predetermined event being executed and a name of a participant participating in the predetermined event. In the present embodiment, the generation unit 67 functions as an example of a generation unit.

The execution and processing unit 68 is mainly implemented by processing of the CPU 601. The execution and processing unit 68 executes various kinds of processing in the event management server 6. The execution and processing unit 68 executes participation processing for a predetermined event. The execution and processing unit 68 executes processing of participating in the predetermined event based on a request from the communication terminal 3, for one of a schedule associated with the communication terminal 3 and a schedule associated with a user who participates in the predetermined event executed in the physical space. The execution and processing unit 68 executes processing of participating in the predetermined event based on a request from the PC 9, for one of a schedule associated with the PC 9, a schedule associated with a user who participates in the predetermined event executed in the virtual space, and a schedule represented by the predetermined event being executed. In the present embodiment, the execution and processing unit 68 functions as an example of an execution unit.

The storing and reading unit 69 is mainly implemented by processing of the CPU 601 on at least one of the ROM 602, the EEPROM 604, the HD 605, and the recording medium 614. The storing and reading unit 69 stores or reads various kinds of data (or information) to or from the storage unit 6000. In the present embodiment, the storing and reading unit 69 functions as an example of a storage control unit.

### Event Management Table

FIG. 9 is an illustration of an example of an event management table according to the embodiment. The structure and content of the data table described below are an example, and are not limited to this example. The storage unit 6000 includes an event management DB 6001 implemented by the event management table illustrated in FIG. 9. The event management table stores and manages, for each event ID, a host ID, event details, a start date and time, an end date and time, a password, and a location link (URL information) in association with one another.

The event ID is identification information for identifying an event such as a meeting. The host ID is identification information for identifying a user who hosts the event among users who participate in the event. The event details present details of the event to be executed. The start date and time and the end date and time indicate dates and times when the event is started and ended. The password is information that is used when the event is executed and is associated with the event details. The location link (URL information) represents location information where a meeting is carried out among terminals (apparatuses) connected to the communication network 100.

In the present embodiment, the event management table (the event management DB 6001) functions as an example of an event management unit.

### Event User Management Table

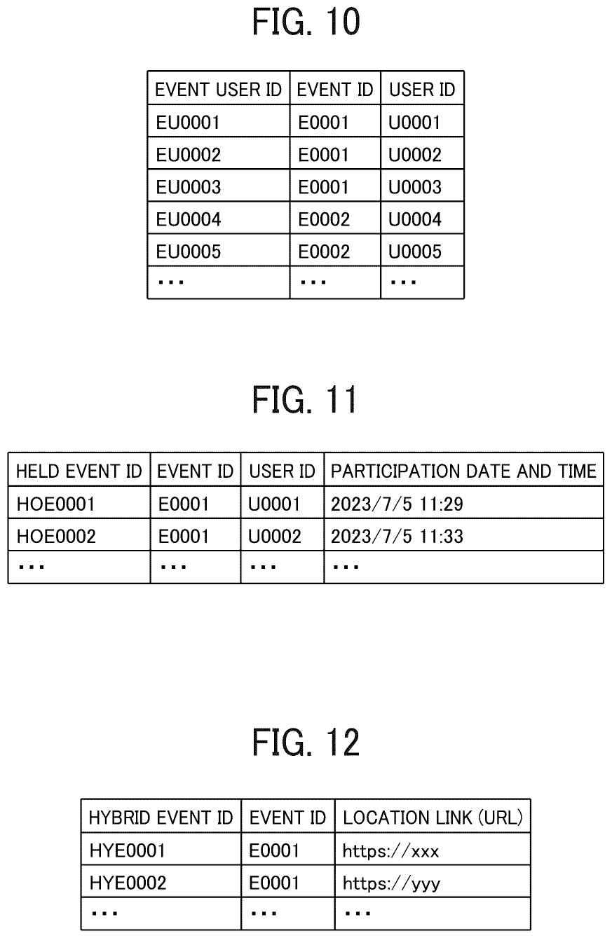

FIG. 10 is an illustration of an example of an event user management table according to the embodiment. The structure and content of the data table described below are an example, and are not limited to this example. The storage unit 6000 includes an event user management DB 6002 implemented by the event user management table illustrated in FIG. 10. The event user management table stores and manages, for each event user ID, an event ID and a user ID in association with each other.

The event user ID is identification information for identifying a user who participates in a predetermined event.

In the present embodiment, the event user management table (the event user management DB 6002) functions as an example of an event user management unit.

### Held Event Management Table

FIG. 11 is an illustration of an example of a held event management table according to the embodiment. The structure and content of the data table described below are an example, and are not limited to this example. The storage unit 6000 includes the held event management DB 6003 implemented by the held event management table illustrated in FIG. 11. The held event management table stores and manages, for each held event ID, an event ID, a user ID, and a participation date and time in association with one another.

The held event ID is identification information for identifying a held event. The participation date and time indicates a date and time of participation of a user represented by the user ID in an event represented by the event ID.

In the present embodiment, the held event management table (the held event management DB 6003) functions as an example of a held event management unit.

### Functional Configuration of Virtual Reality Hybrid Event Management Server

A functional configuration of the virtual reality hybrid event management server 7 will be described next. As illustrated in FIG. 7C, the virtual reality hybrid event management server 7 includes a transmission and reception unit 71, an acquisition unit 73, a connection processing unit 78, and a storing and reading unit 79. Each of these functional units is a function or unit implemented by one or more of the hardware resources illustrated in FIG. 6 operating in response to an instruction from the CPU 701 according to a program for the virtual reality hybrid event management server 7 loaded into the RAM 703 from at least one of the ROM 702, the EEPROM 704, the HD 705, and the recording medium 714. The virtual reality hybrid event management server 7 further includes a storage unit 7000 (an example of a storage unit) which is implemented by at least one of the ROM 702, the EEPROM 704, the HD 705, and the recording medium 714 illustrated in FIG. 6. In the storage unit 7000, a communication program (communication application) for communicating with the communication terminal 3, the event management server 6, the PC 9, and the like via the communication network 100, a browser application, and the like are installed and stored.

Each Functional Unit of Virtual Reality Hybrid Event Management Server Each functional unit of the virtual reality hybrid event management server 7 will be described in detail next. The transmission and reception unit 71 of the virtual reality hybrid event management server 7 illustrated in FIG. 7C is mainly implemented by processing of the CPU 701 on the network I/F 711 and the short-range communication I/F 708. The transmission and reception unit 71 transmits and receives various kinds of data (or information) to and from the communication terminal 3, the event management server 6, the PC 9, and the like via the communication network 100. In the present embodiment, the transmission and reception unit 71 functions as an example of at least one of a transmission unit and a reception unit.

The acquisition unit 73 is mainly implemented by processing of the CPU 701. The acquisition unit 73 acquires various kinds of information (data) received by communication with the communication terminal 3, the event management server 6, the PC 9, and the like. In the present embodiment, the acquisition unit 73 functions as an example of an acquisition unit.

The connection processing unit 78 is mainly implemented by processing of the CPU 701. The connection processing unit 78 executes various kinds of processing for establishing a connection to a virtual reality hybrid event. In the present embodiment, the connection processing unit 78 functions as an example of a processing unit.

The storing and reading unit 79 is mainly implemented by processing of the CPU 701 on at least one of the ROM 702, the EEPROM 704, the HD 705, and the recording medium 714. The storing and reading unit 79 stores or reads various kinds of data (or information) to or from the storage unit 7000. In the present embodiment, the storing and reading unit 79 functions as an example of a storage control unit.

### Hybrid Event Management Table

FIG. 12 is an illustration of an example of a hybrid event management table according to the embodiment. The structure and content of the data table described below are an example, and are not limited to this example. The storage unit 7000 includes a hybrid event management DB 7001 implemented by the hybrid event management table illustrated in FIG. 12. The hybrid event management table stores and manages, for each hybrid event ID, an event ID and a location link (URL information) in association with each other.

The hybrid event ID is identification information for identifying a hybrid event that is held using the physical space and the virtual space.

In the present embodiment, the hybrid event management table (the hybrid event management DB 7001) functions as an example of a hybrid event management unit.

### Functional Configuration of Metaverse Management Server

A functional configuration of the metaverse management server 8 will be described next. As illustrated in FIG. 7C, the metaverse management server 8 includes a transmission and reception unit 81, an acquisition unit 83, an execution and processing unit 88, and a storing and reading unit 89. Each of these functional units is a function or unit implemented by one or more of the hardware resources illustrated in FIG. 6 operating in response to an instruction from the CPU 801 according to a program for the metaverse management server 8 loaded into the RAM 803 from at least one of the ROM 802, the EEPROM 804, the HD 805, and the recording medium 814. The metaverse management server 8 further includes a storage unit 8000 (an example of a storage unit) which is implemented by at least one of the ROM 802, the EEPROM 804, the HD 805, and the recording medium 814 illustrated in FIG. 6. In the storage unit 8000, a communication program (communication application) for communicating with the communication terminal 3, the event management server 6, the PC 9, and the like via the communication network 100, a browser application, and the like are installed and stored.

### Each Functional Unit of Metaverse Management Server

Each functional unit of the metaverse management server 8 will be described in detail next. The transmission and reception unit 81 of the metaverse management server 8 illustrated in FIG. 7C is mainly implemented by processing of the CPU 801 on the network I/F 811 and the short-range communication I/F 808. The transmission and reception unit 81 transmits and receives various kinds of data (or information) to and from the PC 9 and the like via the communication network 100. In the present embodiment, the transmission and reception unit 81 functions as an example of at least one of a transmission unit and a reception unit.

The acquisition unit 83 is mainly implemented by processing of the CPU 801. The acquisition unit 83 acquires various kinds of information (data) received by communication with the PC 9 and the like. In the present embodiment, the acquisition unit 83 functions as an example of an acquisition unit.

The execution and processing unit 88 is mainly implemented by processing of the CPU 801. The execution and processing unit 88 executes various kinds of processing in the metaverse management server 8. In the present embodiment, the execution and processing unit 88 functions as an example of an execution unit.

The storing and reading unit 89 is mainly implemented by processing of the CPU 801 on at least one of the ROM 802, the EEPROM 804, the HD 805, and the recording medium 814. The storing and reading unit 89 stores or reads various kinds of data (or information) to or from the storage unit 8000. In the present embodiment, the storing and reading unit 89 functions as an example of a storage control unit.

### Processing or Operations in Embodiment

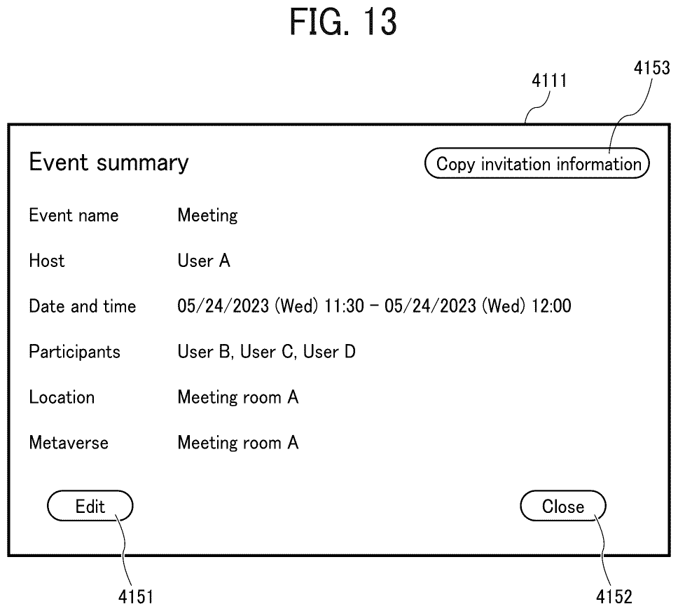

Referring now to FIGS. 13 to 34, processing and operations performed in the information processing system 1 according to the first embodiment will be described.

Display Screen Example of Event Schedule Registration FIG. 13 is a diagram illustrating an example of an event schedule registration screen according to the embodiment. In FIG. 13, the display control unit 44 of the information processing apparatus 4 causes an event schedule registration screen 4111 to be displayed. This event schedule registration screen 4111 may be displayed on the information processing apparatus 4 based on previously set information prior to processing illustrated in various sequence diagrams described below.

The event schedule registration screen 4111 displays, as a summary of an event (an example of an event), an event name, a host, a date and time, participants, a location in the physical space, and a metaverse in the virtual space. The event schedule registration screen 4111 further displays an edit button 4151 that enables editing of the aforementioned various kinds of information, a close button 4152 for closing the event schedule registration screen 4111, and a copy button 4153 that enables copying of invitation information.

### Display Processing of Device-Associated-Event List

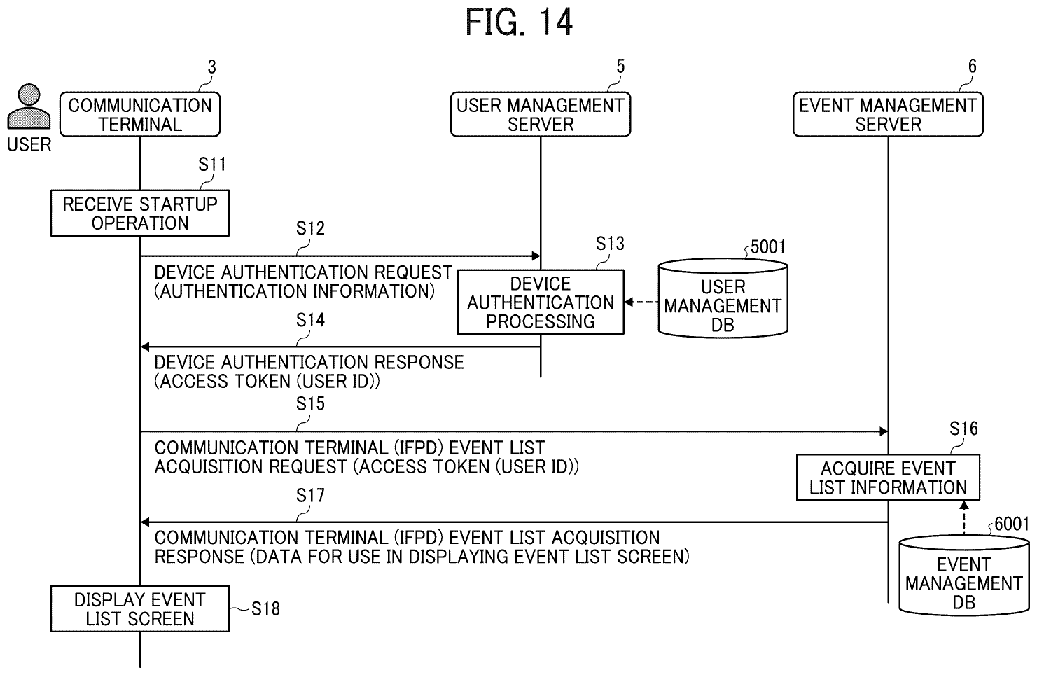

FIG. 14 is a sequence diagram illustrating an example of a process including display processing of a device-associated-event list according to the embodiment. Note that the sequence diagram illustrated in FIG. 14 is an example, and the sequence is not limited to this example. In the first embodiment, description will be given on the assumption that the communication terminal 3 and the user management server 5 have established predetermined communication therebetween and are ready to communicate with each other and the communication terminal 3 and the event management server 6 have established predetermined communication therebetween and are ready to communicate with each other. Likewise, description below will be given also on the assumption that the other apparatuses, terminals, and servers have established predetermined communication therebetween and are ready to communicate with each other.

First, the operation receiving unit 32 of the communication terminal 3 receives a startup operation (step S11). Specifically, the operation receiving unit 32 receives a startup operation on the power switch 322 or the selection switches 323 of the communication terminal 3 by a user who uses the communication terminal 3.

Then, the transmission and reception unit 31 of the communication terminal 3 transmits a device authentication request to the user management server 5 (step S12). Thus, the transmission and reception unit 51 of the user management server 5 receives the device authentication request transmitted by the communication terminal 3. At this time, the device authentication request includes authentication information generated from certificate information and a secret key.

Then, the authentication processing unit 58 of the user management server 5 performs device authentication processing (step S13). Specifically, the authentication processing unit 58 searches the user management DB 5001 (see FIG. 8) via the storing and reading unit 59 by using, as a search key, the authentication information (the certificate information and secret key information) included in the device authentication request received in step S12 to check whether the authentication information matches information managed in the user management DB 5001. The following description is about a case where device authentication is successful.

Then, the transmission and reception unit 51 of the user management server 5 transmits a device authentication response to the communication terminal 3 (step S14). Specifically, the transmission and reception unit 51 transmits, as a response to the device authentication request received in step S12, an access token generated in step S13. Thus, the transmission and reception unit 31 of the communication terminal 3 receives the access token transmitted by the user management server 5.

Then, the transmission and reception unit 31 of the communication terminal 3 transmits a communication terminal event list acquisition request to the event management server 6 (step S15). Thus, the transmission and reception unit 61 of the event management server 6 receives the communication terminal event list acquisition request transmitted by the communication terminal 3. At this time, the communication terminal event list acquisition request includes the access token received in step S14. The access token includes a user ID (host ID) for identifying the user.

Then, the acquisition unit 63 of the event management server 6 acquires event list information (step S16). Specifically, the acquisition unit 63 searches the event management DB 6001 (see FIG. 9) via the storing and reading unit 59 by using, as a search key, the host ID (user ID) in the access token included in the communication terminal event list acquisition request received in step S15, and reads event list information corresponding to one or more events hosted by the user. The event list information read at this time includes, for example, the event ID, the event details (event name), the start date and time, and the end date and time.

Then, the transmission and reception unit 61 of the event management server 6 transmits a communication terminal event list acquisition response to the communication terminal 3 (step S17). Specifically, the transmission and reception unit 61 transmits, as a response to the communication terminal event list acquisition request received in step S15, the communication terminal event list acquisition response including the event list information acquired in step S16. Thus, the transmission and reception unit 31 of the communication terminal 3 receives the communication terminal event list acquisition response transmitted by the event management server 6. At this time, the communication terminal event list acquisition response includes data (such as the event ID, the event details (event name), the start date and time, and the end date and time) for use in displaying an event list screen. Consequently, the acquisition unit 33 of the communication terminal 3 acquires data including the event ID via the transmission and reception unit 31.

Then, the display control unit 34 of the communication terminal 3 causes the event list screen to be displayed (step S18). Specifically, the display control unit 34 causes the display 380 of the communication terminal 3 to display the event list screen which includes the event details, the start date and time, the end date and time, and the location link (URL information).

### Display Screen Example of Device-Associated-Event List

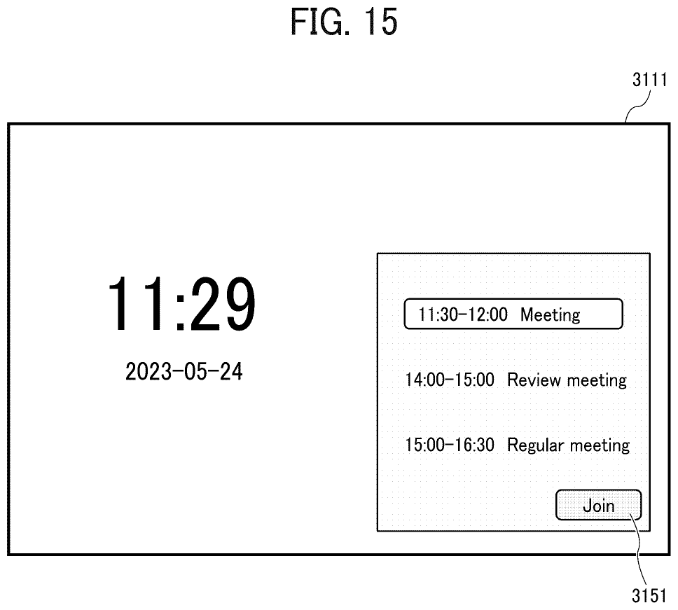

FIG. 15 is a diagram illustrating an example of a display screen of a device-associated-event list according to the embodiment. In FIG. 15, the display control unit 34 of the communication terminal 3 causes an event list screen 3111 to be displayed. The event list screen 3111 displays the current date and time and, as a list of events to be held (or being held) using the communication terminal 3 near the current date and time, sets of the event ID, the event name, the start date and time, and the end date and time. Note that the event ID and the event name (event details) are information items associated with each other. Thus, when the event name is displayed, display of the event ID may be omitted. The event list screen 3111 further displays a join button 3151. Therefore, a user who participates in a predetermined event selects the desired event and operates the join button 3151, and thus can participate in that event.

### Display Processing of User-Associated Event List

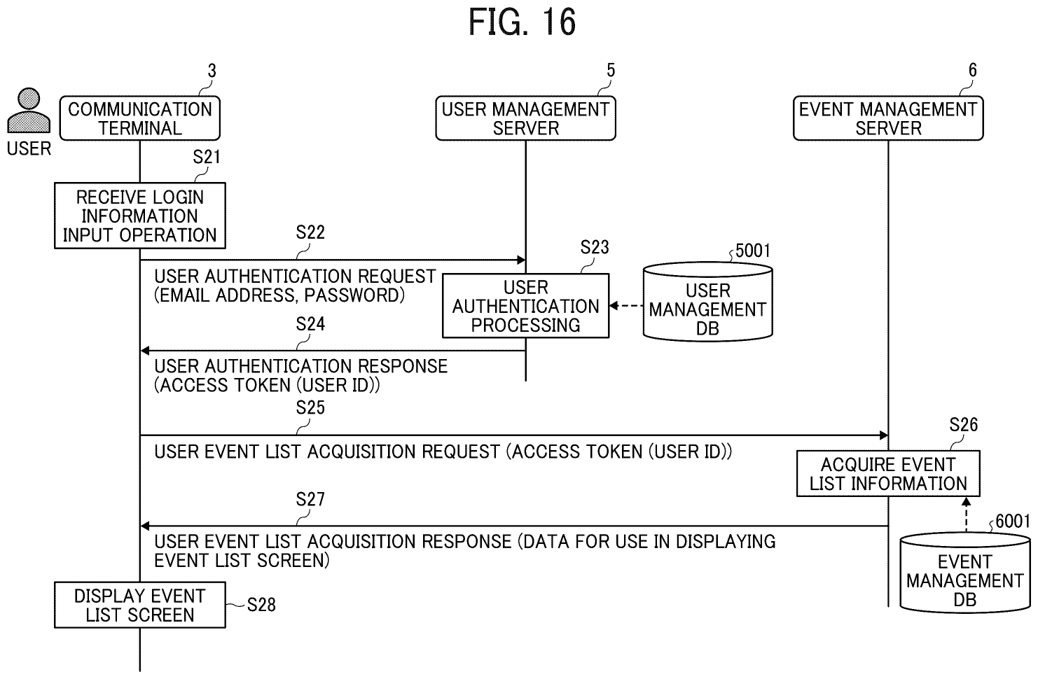

FIG. 16 is a sequence diagram illustrating an example of a process including display processing of a user-associated-event list according to the embodiment. Note that the sequence diagram illustrated in FIG. 16 is an example, and the sequence is not limited to this example.

First, the operation receiving unit 32 of the communication terminal 3 receives a login information input operation (step S21). Specifically, the operation receiving unit 32 receives a login information input operation by a user who uses the communication terminal 3.

Then, the transmission and reception unit 31 of the communication terminal 3 transmits a user authentication request to the user management server 5 (step S22). Thus, the transmission and reception unit 51 of the user management server 5 receives the user authentication request transmitted by the communication terminal 3. At this time, the user authentication request includes an email address and a password given to the user who has input the login information.

Then, the authentication processing unit 58 of the user management server 5 executes user authentication processing (step S23). Specifically, the authentication processing unit 58 searches the user management DB 5001 (see FIG. 8) via the storing and reading unit 59 by using, as a search key, the email address and password included in the user authentication request received in step S22 to check whether the set of the email address and the password matches information managed in the user management DB 5001. The following description is about a case where user authentication is successful.

Then, the transmission and reception unit 51 of the user management server 5 transmits a user authentication response to the communication terminal 3 (step S24). Specifically, the transmission and reception unit 51 transmits, as a response to the user authentication request received in step S22, an access token generated in step S23. Thus, the transmission and reception unit 31 of the communication terminal 3 receives the access token transmitted by the user management server 5.

Then, the transmission and reception unit 31 of the communication terminal 3 transmits a user event list acquisition request to the event management server 6 (step S25). Thus, the transmission and reception unit 61 of the event management server 6 receives the user event list acquisition request transmitted by the communication terminal 3. At this time, the user event list acquisition request includes the access token received in step S24. The access token includes a user ID (host ID) for identifying the user.

Then, the acquisition unit 63 of the event management server 6 acquires event list information (step S26). Specifically, the acquisition unit 63 searches the event management DB 6001 (see FIG. 9) via the storing and reading unit 59 by using, as a search key, the host ID (user ID) in the access token included in the user event list acquisition request received in step S25, and reads event list information corresponding to one or more events hosted by the user. The event list information read at this time includes, for example, the event ID, the event details (event name), the start date and time, and the end date and time.

Then, the transmission and reception unit 61 of the event management server 6 transmits a user event list acquisition response to the communication terminal 3 (step S27). Specifically, the transmission and reception unit 61 transmits, as a response to the user event list acquisition request received in step S25, the user event list acquisition response including the event list information acquired in step S26. Thus, the transmission and reception unit 31 of the communication terminal 3 receives the user event list acquisition response transmitted by the event management server 6. At this time, the user event list acquisition response includes data (such as the event ID, the event details (event name), the start date and time, and the end date and time) for use in displaying an event list screen.

Then, the display control unit 34 of the communication terminal 3 causes the event list screen to be displayed (step S28). Specifically, the display control unit 34 causes the display 380 of the communication terminal 3 to display the event list screen which includes the event details, the start date and time, the end date and time, and the location link (URL information).

In the information processing system 1 according to the present embodiment, when the above-described processing of steps S12 and S14 and the above-described processing of steps S22 and S24 are executed, another apparatus or the like may be present between the communication terminal 3 and the user management server 5, for example. That is, information (data) transmitted and received between the communication terminal 3 and the user management server 5 may be transmitted and received via another apparatus or the like. The above-described configuration is also applicable to the case where another processing step is present between the processing step of the communication terminal 3 and the processing step of the user management server 5.

In the information processing system 1 according to the present embodiment, when the above-described processing of steps S15 and S17 and the above-described processing of steps S25 and S27 are executed, another apparatus or the like may be present between the communication terminal 3 and the event management server 6, for example. That is, information (data) transmitted and received between the communication terminal 3 and the event management server 6 may be transmitted and received via another apparatus or the like. The above-described configuration is also applicable to the case where another processing step is present between the processing step of the communication terminal 3 and the processing step of the event management server 6.

### Display Screen Example of User-Associated-Event List

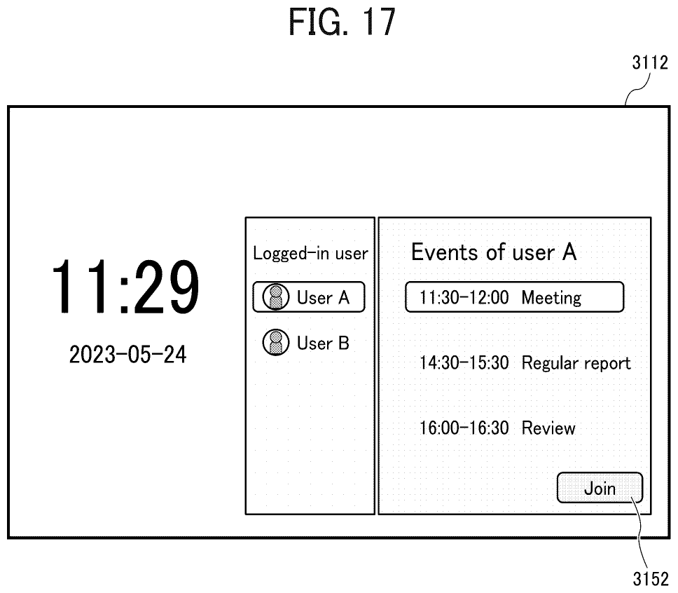

FIG. 17 is a diagram illustrating an example of a display screen of a user-associated-event list according to the embodiment. In FIG. 17, the display control unit 34 of the communication terminal 3 causes an event list screen 3112 to be displayed. The event list screen 3112 displays the current date and time and a list of events (meetings) associated with a user A near the current date and time. The event list screen 3112 further displays a join button 3152. Therefore, a user who participates in a predetermined event selects the desired event and operates the join button 3152, and thus can participate in that event.

Processing of Participating in Event from Communication Terminal

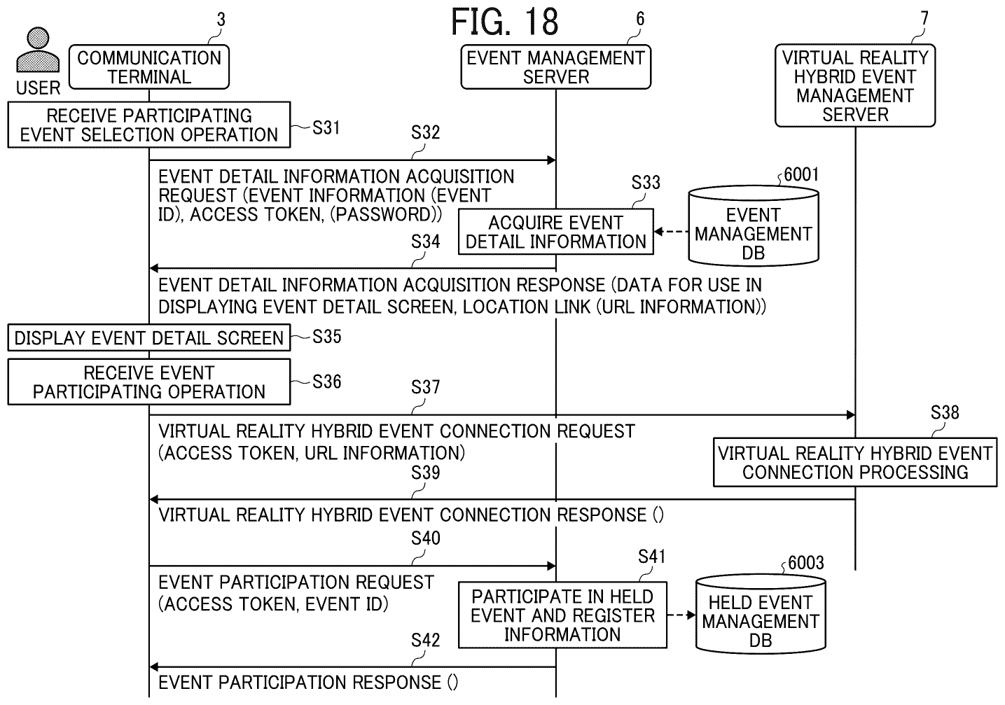

FIG. 18 is a sequence diagram illustrating an example of processing of participating in an event from the communication terminal according to the embodiment.

First, the operation receiving unit 32 of the communication terminal 3 receives a participating event selection operation (step S31). Specifically, the operation receiving unit 32 receives a participating event selection operation performed by a user who uses the communication terminal 3. Note that no restriction is often applied to users who use the communication terminal 3. In such a case, all users in a meeting room which is the physical space can use the communication terminal 3. However, access to meeting information or to a virtual reality hybrid event (meeting) may be restricted. In such a case, authentication using a password or the like may be performed to acquire details of a meeting.

### Password Information Input Screen

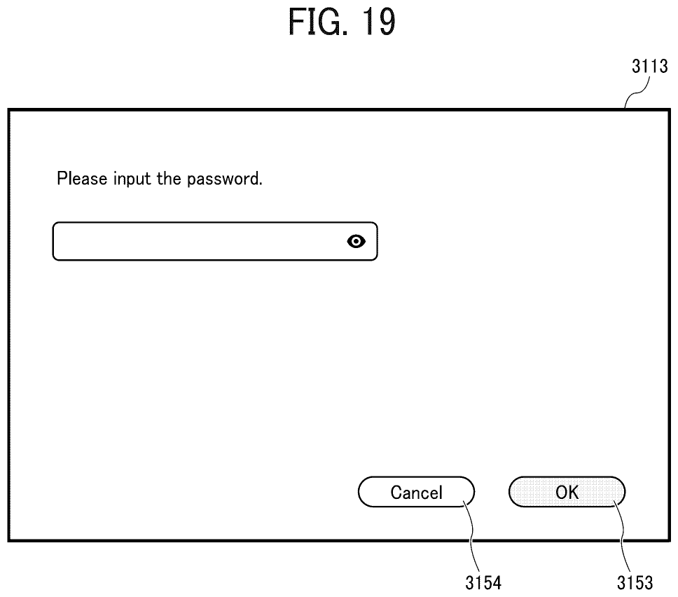

FIG. 19 is a diagram illustrating an example of a password information input screen according to the embodiment. In FIG. 19, the display control unit 34 of the communication terminal 3 causes a password information input screen 3113 to be displayed.

The password information input screen 3113 displays a password input field in which the password is to be input, an OK button 3153, and a cancel button 3154. This can provide a mechanism that hinders a user from acquiring the details of the meeting unless the user passes authentication by inputting the password or the like.

Referring back to FIG. 18, the transmission and reception unit 31 of the communication terminal 3 transmits an event detail information acquisition request to the event management server 6 (step S32). Thus, the transmission and reception unit 61 of the event management server 6 receives the event detail information acquisition request transmitted by the communication terminal 3. At this time, the event detail information acquisition request includes event information which includes an event ID, an access token, and password information given as appropriate.

Then, the acquisition unit 63 of the event management server 6 acquires event detail information (step S33). Specifically, the acquisition unit 63 searches the event management DB 6001 (see FIG. 9) via the storing and reading unit 69 by using, as a search key, the access token included in the event detail information acquisition request received in step S32, and reads corresponding event detail information. At this time, the event detail information includes a location link (URL information) as data for use in displaying an event detail screen.

Then, the transmission and reception unit 61 of the event management server 6 transmits an event detail information acquisition response to the communication terminal 3 (step S34). Specifically, the transmission and reception unit 61 transmits, as a response to the event detail information acquisition request received in step S32, the event detail information read in step S33. Thus, the transmission and reception unit 31 of the communication terminal 3 receives the event detail information acquisition response. At this time, the event detail information acquisition response includes data (such as the event ID, the event details (event name), the start date and time, the end date and time, the participant names, and the location link (URL information)) for use in displaying the event detail screen.

Then, the display control unit 34 of the communication terminal 3 causes the event detail screen to be displayed (step S35). Note that the screen displayed in this processing may have contents similar to those of the event schedule registration screen 4111 described above with reference to FIG. 13.

Then, the operation receiving unit 32 of the communication terminal 3 receives an event participating operation (step S36). Specifically, the operation receiving unit 32 receives an operation performed by the user on a join button or the like for participating in the predetermined event.

Then, the transmission and reception unit 31 of the communication terminal 3 transmits a virtual reality hybrid event connection request to the virtual reality hybrid event management server 7 (step S37). Thus, the transmission and reception unit 71 of the virtual reality hybrid event management server 7 receives the virtual reality hybrid event connection request transmitted by the communication terminal 3. At this time, the virtual reality hybrid event connection request includes the access token and the URL information that represents the location link of the virtual reality hybrid event included in the event detail information.

Then, the connection processing unit 78 of the virtual reality hybrid event management server 7 executes virtual reality hybrid event connection processing (step S38). Specifically, based on the URL information included in the virtual reality hybrid event connection request received in step S37, the connection processing unit 78 performs the virtual reality hybrid event connection processing.

Then, the transmission and reception unit 71 of the virtual reality hybrid event management server 7 transmits a virtual reality hybrid event connection response to the communication terminal 3 (step S39). Specifically, the transmission and reception unit 71 transmits, as a response to the virtual reality hybrid event connection request received in step S37, the virtual reality hybrid event connection response to the communication terminal 3. Thus, the transmission and reception unit 31 of the communication terminal 3 receives the virtual reality hybrid event connection response transmitted by the virtual reality hybrid event management server 7.

Then, the transmission and reception unit 31 of the communication terminal 3 transmits an event participation request to the event management server 6 (step S40). Thus, the transmission and reception unit 61 of the event management server 6 receives the event participation request transmitted by the communication terminal 3. At this time, the event participation request includes the access token and the event ID.

Then, the execution and processing unit 68 of the event management server 6 executes held event participation processing, and the registration unit 66 of the event management server 6 registers held event information (step S41). Specifically, the execution and processing unit 68 executes processing of participating in the predetermined held event. Then, the registration unit 66 registers, for each held event ID managed in the held event management DB 6003 (see FIG. 11), the user ID associated with the event ID received in step S40 and the participation date and time. Note that the participation date and time may be a reception date and time of the event participation request in step S40 or an execution date and time of the processing in step S41.

Then, the transmission and reception unit 61 of the event management server 6 transmits an event participation response to the communication terminal 3 (step S42). Specifically, the transmission and reception unit 61 transmits, as a response to the event participation request received in step S40, the event participation response to the communication terminal 3. At this time, the event participation response may include, as contents thereof, any information indicating that the user has participated in the event.

In the information processing system 1 according to the present embodiment, when the above-described processing of steps S37 and S39 is executed, another apparatus or the like may be present between the communication terminal 3 and the virtual reality hybrid event management server 7, for example. That is, information (data) transmitted and received between the communication terminal 3 and the virtual reality hybrid event management server 7 may be transmitted and received via another apparatus or the like. The above-described configuration is also applicable to the case where another processing step is present between the processing step of the communication terminal 3 and the processing step of the virtual reality hybrid event management server 7.

### Display Processing of Metaverse-Associated-Event List

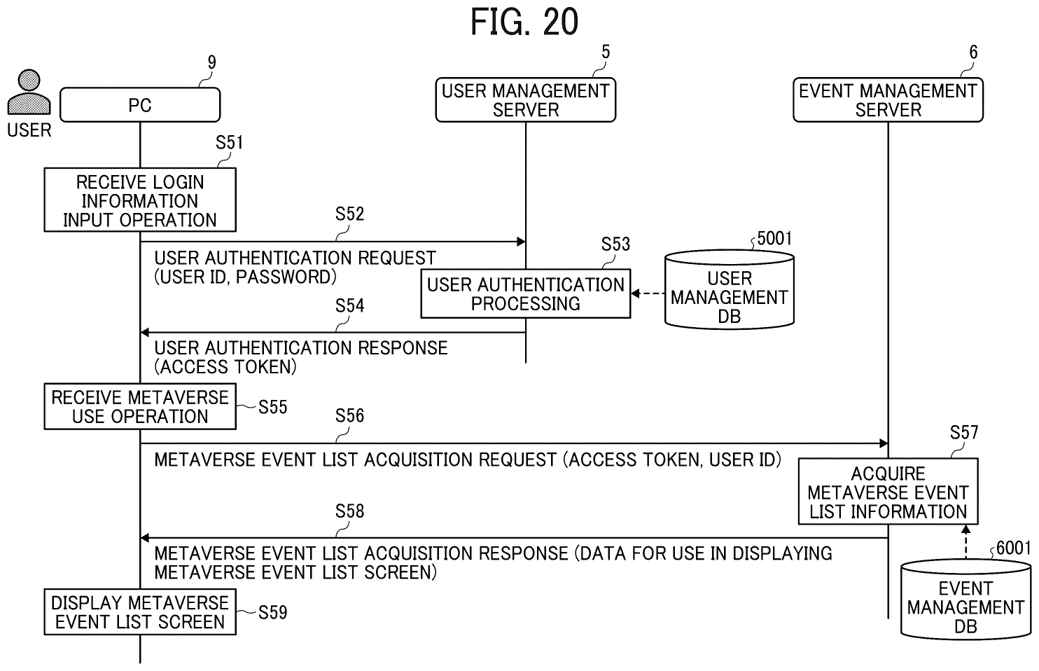

FIG. 20 is a sequence diagram illustrating an example of a process including display processing of a metaverse-associated-event list according to the embodiment.

First, the operation receiving unit 92 of the PC 9 receives a login information input operation (step S51). Specifically, the operation receiving unit 92 receives a login information input operation by a user who uses the PC 9.

Then, the transmission and reception unit 91 of the PC 9 transmits a user authentication request to the user management server 5 (step S52). Thus, the transmission and reception unit 51 of the user management server 5 receives the user authentication request transmitted by the PC 9. At this time, the user authentication request includes a user ID and a password for use in authentication of the user.

Then, the authentication processing unit 58 of the user management server 5 executes user authentication processing (step S53). Specifically, the authentication processing unit 58 searches the user management DB 5001 (see FIG. 8) via the storing and reading unit 59 by using, as a search key, the user ID and password included in the user authentication request received in step S52, and reads a corresponding access token.

Then, the transmission and reception unit 51 of the user management server 5 transmits a user authentication response to the PC 9 (step S54). Thus, the transmission and reception unit 91 of the PC 9 receives the user authentication response transmitted by the user management server 5. At this time, the user authentication response includes the access token.

Then, the operation receiving unit 92 of the PC 9 receives a metaverse use operation (step S55). Specifically, the operation receiving unit 92 receives a metaverse use operation performed by the user.

Then, the transmission and reception unit 91 of the PC 9 transmits a metaverse event list acquisition request to the event management server 6 (step S56). Thus, the transmission and reception unit 61 of the event management server 6 receives the metaverse event list acquisition request transmitted by the PC 9. At this time, the metaverse event list acquisition request includes the access token and the user ID that enables identification of the metaverse.

Then, the acquisition unit 63 of the event management server 6 acquires metaverse event list information (step S57). Specifically, the acquisition unit 63 searches the event management DB 6001 (see FIG. 9) via the storing and reading unit 69 by using, as a search key, the login information (user ID) of the user included in the metaverse event list acquisition request received in step S56, and reads corresponding event list information. The event list information read at this time includes, for example, the event ID, the event details (event name), the start date and time, and the end date and time.

Then, the transmission and reception unit 61 of the event management server 6 transmits a metaverse event list acquisition response to the PC 9 (step S58). Specifically, the transmission and reception unit 61 transmits, as a response to the metaverse event list acquisition request received in step S56, the metaverse event list acquisition response including the metaverse event list information acquired in step S57. Thus, the transmission and reception unit 91 of the PC 9 receives the metaverse event list acquisition response transmitted by the event management server 6. At this time, the metaverse event list acquisition response includes, as data for use in displaying a metaverse event list screen, the event ID, the host ID (user ID), the event details, the start date and time, the end date and time, the location link (URL information), participant information of the event being held.

Then, the display control unit 94 of the PC 9 causes the metaverse event list screen to be displayed (step S59). Specifically, the display control unit 94 causes the display 907 of the PC 9 to display the metaverse event list screen.

In the information processing system 1 according to the present embodiment, when the above-described processing of steps S52 and S54 is executed, another apparatus or the like may be present between the PC 9 and the user management server 5, for example. That is, information (data) transmitted and received between the PC 9 and the user management server 5 may be transmitted and received via another apparatus or the like. The above-described configuration is also applicable to the case where another processing step is present between the processing step of the PC 9 and the processing step of the user management server 5.

In the information processing system 1 according to the present embodiment, when the above-described processing of steps S56 and S58 is executed, another apparatus or the like may be present between the PC 9 and the event management server 6, for example. That is, information (data) transmitted and received between the PC 9 and the event management server 6 may be transmitted and received via another apparatus or the like. The above-described configuration is also applicable to the case where another processing step is present between the processing step of the PC 9 and the processing step of the event management server 6.

### Display Screen Example of Metaverse-Associated-Event List

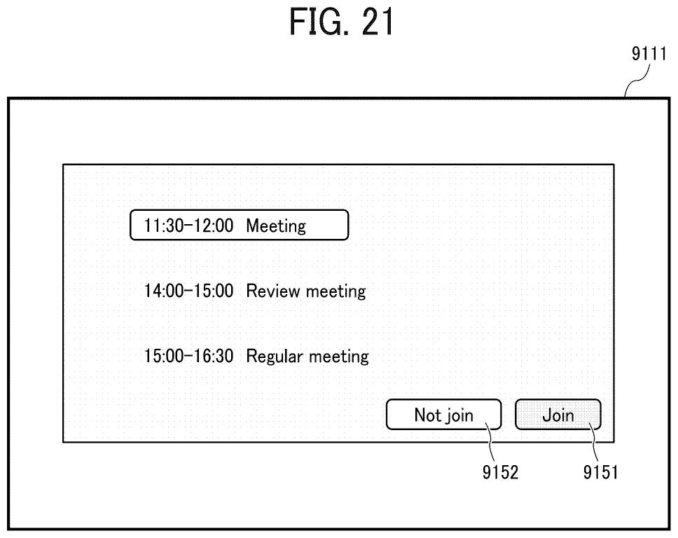

FIG. 21 is a diagram illustrating an example of a display screen of a metaverse-associated-event list according to the embodiment.

In FIG. 21, the display control unit 94 of the PC 9 causes an event list screen 9111 to be displayed.

The event list screen 9111 displays a list of metaverse events. The event list screen 9111 further displays a join button 9151 for participating in an event, and a not join button 9152 for not participating in an event. Therefore, a user who participates in a predetermined event selects the desired event and operates the join button 9151, and thus can participate in that event.

### Display Processing of User-Associated Event List

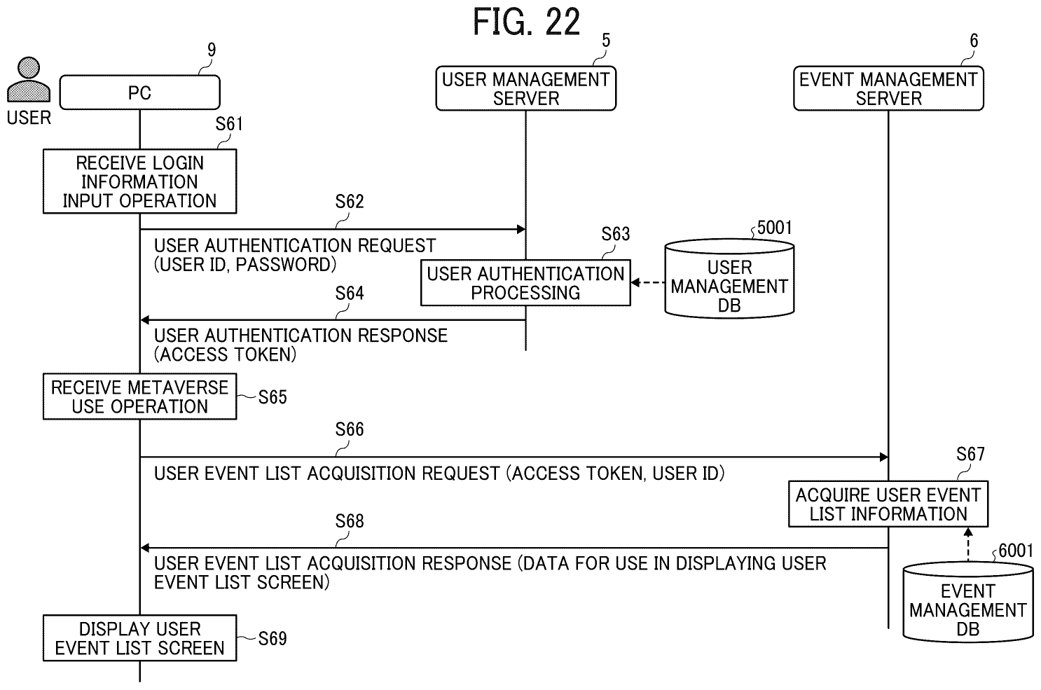

FIG. 22 is a sequence diagram illustrating an example of a process including display processing of a user-associated-event list according to the embodiment.

First, the operation receiving unit 92 of the PC 9 receives a login information input operation (step S61). Specifically, the operation receiving unit 92 receives a login information input operation by a user who uses the PC 9.

Then, the transmission and reception unit 91 of the PC 9 transmits a user authentication request to the user management server 5 (step S62). Thus, the transmission and reception unit 51 of the user management server 5 receives the user authentication request transmitted by the PC 9. At this time, the user authentication request includes a user ID and a password for use in authentication of the user.

Then, the authentication processing unit 58 of the user management server 5 executes user authentication processing (step S63). Specifically, the authentication processing unit 58 searches the user management DB 5001 (see FIG. 8) via the storing and reading unit 59 by using, as a search key, the user ID and password included in the user authentication request received in step S62, and reads a corresponding access token.

Then, the transmission and reception unit 51 of the user management server 5 transmits a user authentication response to the PC 9 (step S64). Thus, the transmission and reception unit 91 of the PC 9 receives the user authentication response transmitted by the user management server 5. At this time, the user authentication response includes the access token.

Then, the operation receiving unit 92 of the PC 9 receives a metaverse use operation (step S65). Specifically, the operation receiving unit 92 receives a metaverse (virtual space) use operation performed by the user.

Then, the transmission and reception unit 91 of the PC 9 transmits a user event list acquisition request to the event management server 6 (step S66). Thus, the transmission and reception unit 61 of the event management server 6 receives the user event list acquisition request transmitted by the PC 9. At this time, the user event list acquisition request includes the access token and the user ID that enables identification of the metaverse.

Then, the acquisition unit 63 of the event management server 6 acquires user event list information (step S67). Specifically, the acquisition unit 63 searches the event management DB 6001 (see FIG. 9) via the storing and reading unit 69 by using, as a search key, the login information (user ID) of the user included in the user event list acquisition request received in step S66, and reads corresponding event list information. The event list information read at this time includes, for example, the event ID, the event details (event name), the start date and time, and the end date and time.

Then, the transmission and reception unit 61 of the event management server 6 transmits a user event list acquisition response to the PC 9 (step S68). Specifically, the transmission and reception unit 61 transmits, as a response to the user event list acquisition request received in step S66, the user event list acquisition response including the user event list information acquired in step S67. Thus, the transmission and reception unit 91 of the PC 9 receives the user event list acquisition response transmitted by the event management server 6. At this time, the user event list acquisition response includes, as data for use in displaying a user event list screen, the event ID, the host ID (user ID), the event details, the start date and time, the end date and time, the location link (URL information), participant information of the event being held.

Then, the display control unit 94 of the PC 9 causes the user event list screen to be displayed (step S69). Specifically, the display control unit 94 causes the display 907 of the PC 9 to display the user event list screen.

Event Participation Coordination Processing between Communication Terminal and Metaverse

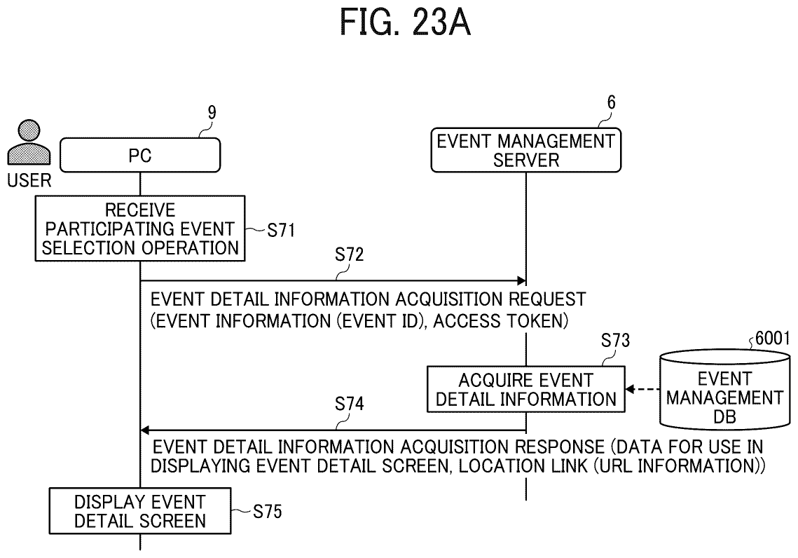

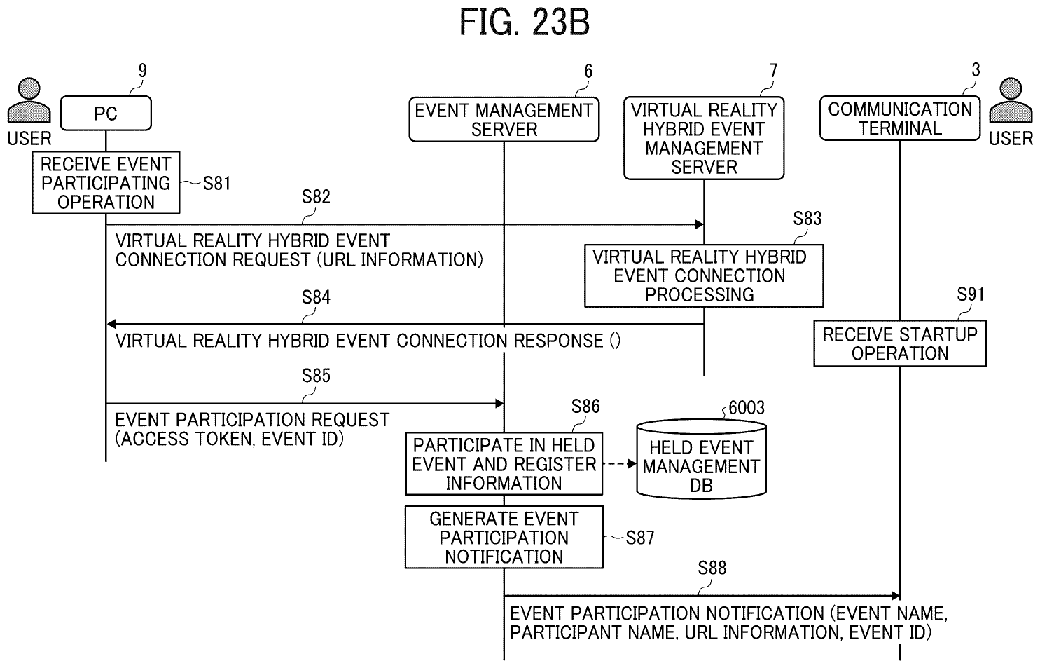

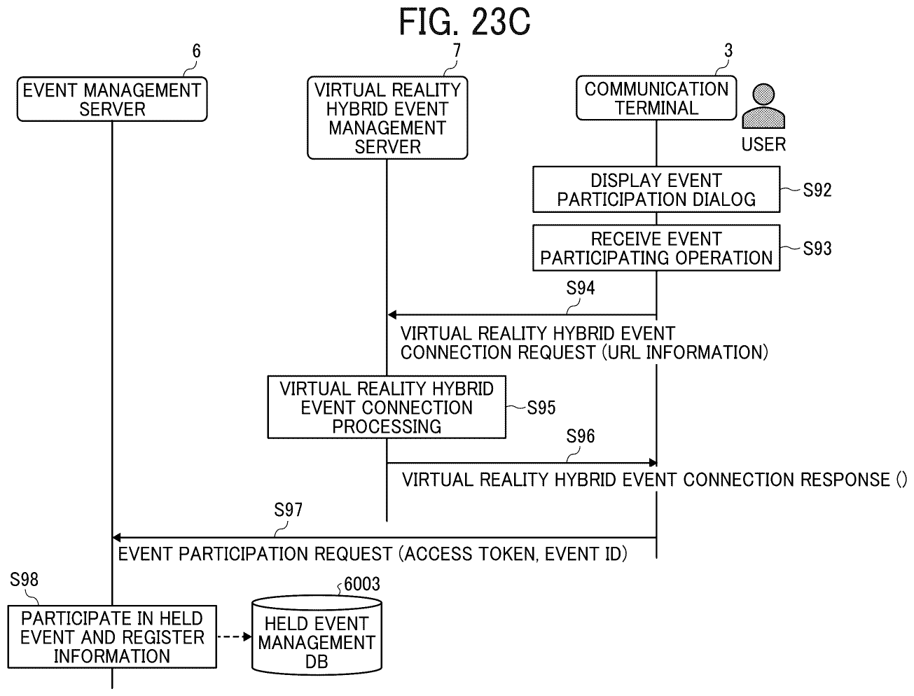

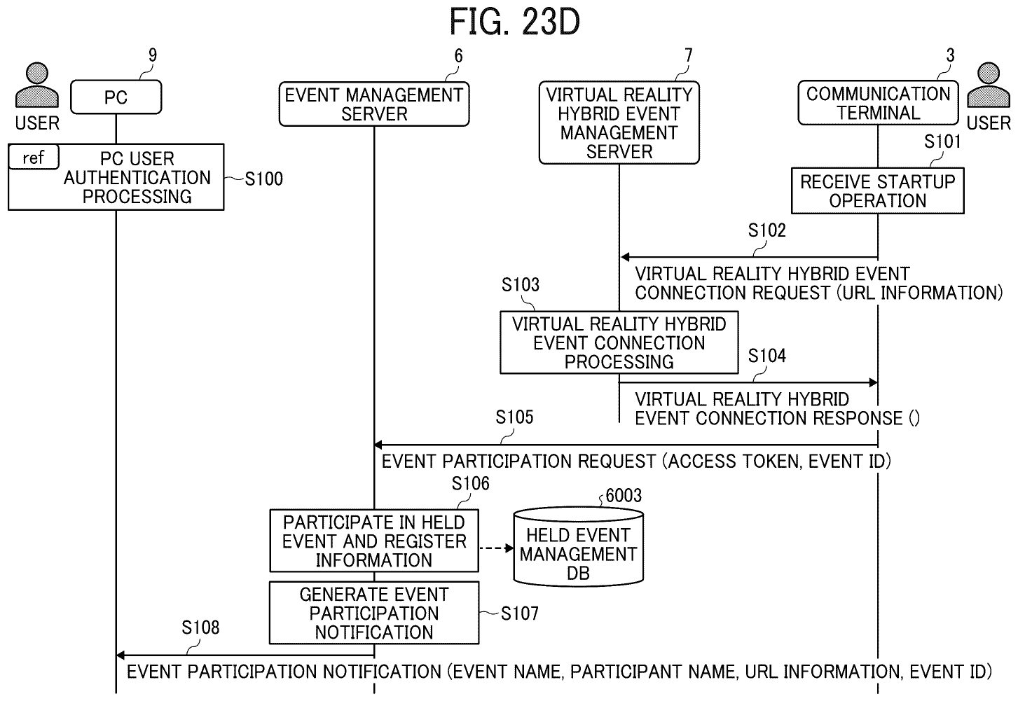

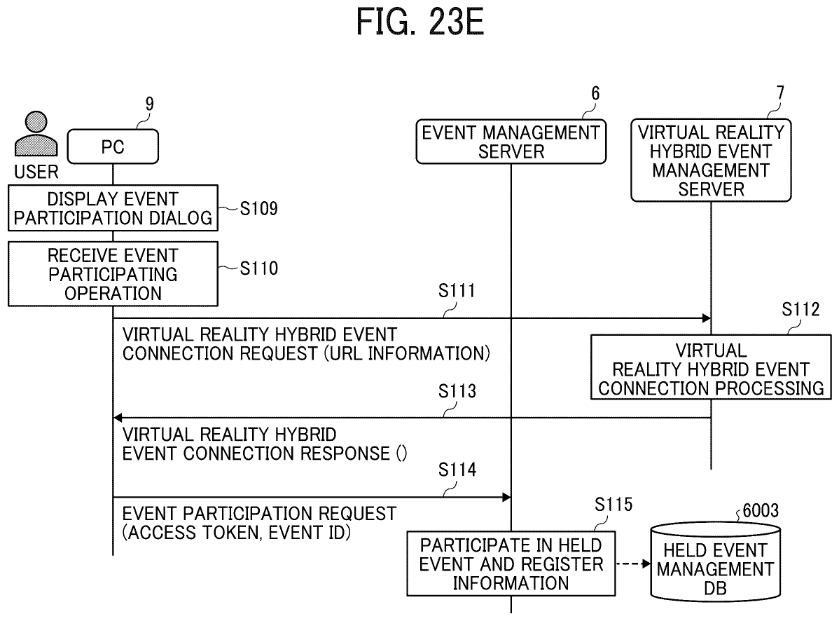

Event participation coordination processing between the communication terminal and the metaverse will be described next. FIG. 23A is a sequence diagram illustrating an example of a process including event participation coordination processing between the communication terminal and the metaverse according to the embodiment.

First, the operation receiving unit 92 of the PC 9 receives a participating event selection operation (step S71). Specifically, the operation receiving unit 92 receives a participating event selection operation performed by a user who uses the PC 9.

Then, the transmission and reception unit 91 of the PC 9 transmits an event detail information acquisition request to the event management server 6 (step S72). Thus, the transmission and reception unit 61 of the event management server 6 receives the event detail information acquisition request transmitted by the PC 9. At this time, the event detail information acquisition request includes an access token and event information including an event ID.

Then, the acquisition unit 63 of the event management server 6 acquires event detail information (step S73). Specifically, the acquisition unit 63 searches the event management DB 6001 (see FIG. 9) via the storing and reading unit 69 by using, as a search key, the access token included in the event detail information acquisition request received in step S72, and reads corresponding event detail information. At this time, the event detail information includes a location link (URL information) as data for use in displaying an event detail screen.

Then, the transmission and reception unit 61 of the event management server 6 transmits an event detail information acquisition response to the PC 9 (step S74). Specifically, the transmission and reception unit 61 transmits, as a response to the event detail information acquisition request received in step S72, the event detail information read in step S73. Thus, the transmission and reception unit 91 of the PC 9 receives the event detail information acquisition response.

At this time, the event detail information acquisition response includes data (such as the location link (URL information)) for use in displaying the event detail screen.

Then, the display control unit 94 of the PC 9 causes the event detail screen to be displayed (step S75). Note that the screen displayed in this processing may have contents similar to those of the event schedule registration screen 4111 described above with reference to FIG. 13.

FIG. 23B is a sequence diagram illustrating another example of the process including the event participation coordination processing between the communication terminal and the metaverse according to the embodiment.

First, the operation receiving unit 92 of the PC 9 receives an event participating operation (step S81). Specifically, the operation receiving unit 92 receives an event participating operation performed by a user who uses the PC 9.

Then, the transmission and reception unit 91 of the PC 9 transmits a virtual reality hybrid event connection request to the virtual reality hybrid event management server 7 (step S82). Thus, the transmission and reception unit 71 of the virtual reality hybrid event management server 7 receives the virtual reality hybrid event connection request transmitted by the PC 9. At this time, the virtual reality hybrid event connection request includes the URL information.

Then, the connection processing unit 78 of the virtual reality hybrid event management server 7 executes virtual reality hybrid event connection processing (step S83).

Then, the transmission and reception unit 71 of the virtual reality hybrid event management server 7 transmits a virtual reality hybrid event connection response to the PC 9 (step S84). Specifically, the transmission and reception unit 71 transmits, as a response to the virtual reality hybrid event connection request received in step S82, a result of the virtual reality hybrid event connection processing executed in step S83. Thus, the transmission and reception unit 91 of the PC 9 receives the virtual reality hybrid event connection response.

Then, the transmission and reception unit 91 of the PC 9 transmits an event participation request to the event management server 6 (step S85). Thus, the transmission and reception unit 61 of the event management server 6 receives the event participation request transmitted by the PC 9. At this time, the event participation request includes the access token, which is one kind of user identification information for identifying the user, and the event ID.

Then, the execution and processing unit 68 of the event management server 6 executes held event participation processing, and the registration unit 66 of the event management server 6 registers held event information (step S86). Specifically, the execution and processing unit 68 executes processing of participating in the predetermined held event. Then, the registration unit 66 registers, for each held event ID managed in the held event management DB 6003 (see FIG. 11), the user ID associated with the event ID received in step S85 and the participation date and time. Note that the participation date and time may be a reception date and time of the event participation request in step S85 or an execution date and time of the processing in step S86.

Then, the generation unit 67 of the event management server 6 generates an event participation notification (step S87). Specifically, the generation unit 67 generates, as the event participation notification, a notification including an event name and a name of a participant of the event that are used to display an event participation dialog (described later), URL information used in a virtual reality hybrid event connection request (described later), and an event ID used in an event participation request (described later). Note that in step S87, the generation unit 67 generates the event participation notification, based on the participation date and time of participation of the PC 9 in the predetermined event. In step S87, the generation unit 67 generates, as the event participation notification, a notification including an event name representing the predetermined event being executed and a name of a participant participating in the predetermined event.

Then, the transmission and reception unit 61 of the event management server 6 transmits the event participation notification generated in step S87 to the communication terminal 3 (step S88). Thus, the transmission and reception unit 31 of the communication terminal 3 receives the event participation notification transmitted by the event management server 6.

On the other hand, the operation receiving unit 32 of the communication terminal 3 receives a startup operation asynchronously with the above-described processing of steps S81 to S88 (step S91).

FIG. 23C is a sequence diagram illustrating another example of the process including the event participation coordination processing between the communication terminal and the metaverse according to the embodiment. The display control unit 34 of the communication terminal 3 causes an event participation dialog to be displayed (step S92). Specifically, the display control unit 34 causes the display 380 of the communication terminal 3 to display the event participation dialog which is an example of the event participation notification received from the event management server 6. More specifically, the display control unit 34 causes the display 380 to display, as the event participation notification, a dialog to be operated on the communication terminal 3 by the user who uses the communication terminal 3.

### Event Participation Dialog Screen

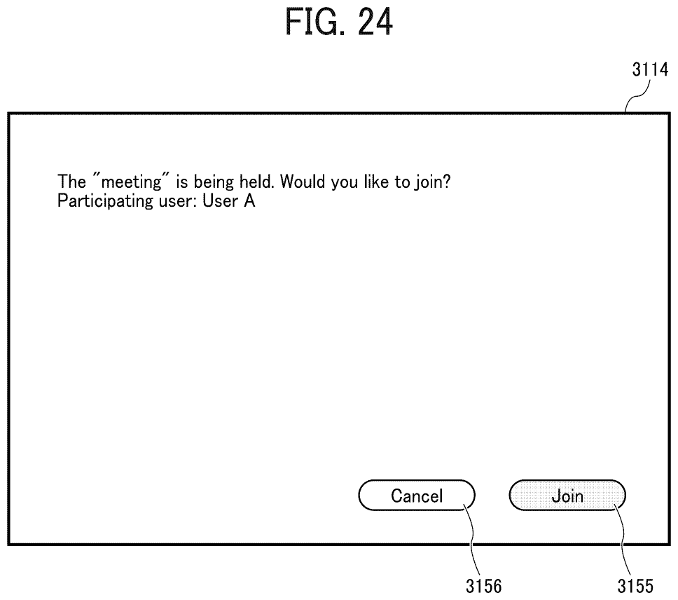

FIG. 24 is a diagram illustrating an example screen of an event participation dialog according to the embodiment. In FIG. 24, the display control unit 34 of the communication terminal 3 causes an event participation dialog 3114 to be displayed. The event participation dialog 3114 displays a message indicating that the meeting is being held, a user name of a participant, a join button 3155, and a cancel button 3156. Therefore, a user who is scheduled to participate in but has not participated in the predetermined event operates the join button 3155, and thus can participate in the predetermined event.

Referring back to FIG. 23C, the operation receiving unit 32 of the communication terminal 3 receives an event participation notification (operation) (step S93). Specifically, the operation receiving unit 32 receives an operation on the join button 3155 described in FIG. 24.

Then, the transmission and reception unit 31 of the communication terminal 3 transmits a virtual reality hybrid event connection request to the virtual reality hybrid event management server 7 (step S94). Thus, the transmission and reception unit 71 of the virtual reality hybrid event management server 7 receives the virtual reality hybrid event connection request transmitted by the communication terminal 3. At this time, the virtual reality hybrid event connection request includes the URL information.

Then, the connection processing unit 78 of the virtual reality hybrid event management server 7 executes virtual reality hybrid event connection processing (step S95).

Then, the transmission and reception unit 71 of the virtual reality hybrid event management server 7 transmits a virtual reality hybrid event connection response to the communication terminal 3 (step S96). Specifically, the transmission and reception unit 71 transmits, as a response to the virtual reality hybrid event connection request received in step S94, a result of the virtual reality hybrid event connection processing executed in step S95. Thus, the transmission and reception unit 31 of the communication terminal 3 receives the virtual reality hybrid event connection response transmitted by the virtual reality hybrid event management server 7.

Then, the transmission and reception unit 31 of the communication terminal 3 transmits an event participation request to the event management server 6 (step S97). Thus, the transmission and reception unit 61 of the event management server 6 receives the event participation request transmitted by the communication terminal 3. At this time, the event participation request includes the access token, which is one kind of user identification information for identifying the user, and the event ID.

Then, the execution and processing unit 68 of the event management server 6 executes held event participation processing, and the registration unit 66 of the event management server 6 registers held event information (step S98). Specifically, the execution and processing unit 68 executes processing of participating in a predetermined held event. Then, the registration unit 66 registers, for each held event ID managed in the held event management DB 6003 (see FIG. 11), the user ID associated with the event ID received in step S97 and the participation date and time. Note that the participation date and time may be a reception date and time of the event participation request in step S97 or an execution date and time of the processing in step S98.

In the information processing system 1 according to the present embodiment, when the above-described processing of steps S82 and S84 is executed, another apparatus or the like may be present between the PC 9 and the virtual reality hybrid event management server 7, for example. That is, information (data) transmitted and received between the PC 9 and the virtual reality hybrid event management server 7 may be transmitted and received via another apparatus or the like. The above-described configuration is also applicable to the case where another processing step is present between the processing step of the PC 9 and the processing step of the virtual reality hybrid event management server 7.

FIG. 23D is a sequence diagram illustrating another example of the process including the event participation coordination processing between the communication terminal and the metaverse according to the embodiment.

First, the execution control unit 98 of the PC 9 performs PC user authentication processing (step S100).

Note that since the processing of step S100 is substantially the same as the above-described user authentication processing performed for the PC 9, detailed description is omitted.

The operation receiving unit 32 of the communication terminal 3 receives a startup operation asynchronously with the above-described processing of step S100 (step S101).

Then, the transmission and reception unit 31 of the communication terminal 3 transmits a virtual reality hybrid event connection request to the virtual reality hybrid event management server 7 (step S102). Thus, the transmission and reception unit 71 of the virtual reality hybrid event management server 7 receives the virtual reality hybrid event connection request transmitted by the communication terminal 3. At this time, the virtual reality hybrid event connection request includes the URL information.

Then, the connection processing unit 78 of the virtual reality hybrid event management server 7 executes virtual reality hybrid event connection processing (step S103).

Then, the transmission and reception unit 71 of the virtual reality hybrid event management server 7 transmits a virtual reality hybrid event connection response to the communication terminal 3 (step S104). Specifically, the transmission and reception unit 71 transmits, as a response to the virtual reality hybrid event connection request received in step S102, a result of the virtual reality hybrid event connection processing executed in step S103. Thus, the transmission and reception unit 31 of the communication terminal 3 receives the virtual reality hybrid event connection response transmitted by the virtual reality hybrid event management server 7.

Then, the transmission and reception unit 31 of the communication terminal 3 transmits an event participation request to the event management server 6 (step S105). Thus, the transmission and reception unit 61 of the event management server 6 receives the event participation request transmitted by the communication terminal 3. At this time, the event participation request includes the access token, which is one kind of user identification information for identifying the user, and the event ID.

Then, the execution and processing unit 68 of the event management server 6 executes held event participation processing, and the registration unit 66 of the event management server 6 registers held event information (step S106). Specifically, the execution and processing unit 68 executes processing of participating in a predetermined held event. Then, the registration unit 66 registers, for each held event ID managed in the held event management DB 6003 (see FIG. 11), the user ID associated with the event ID received in step S105 and the participation date and time. Note that the participation date and time may be a reception date and time of the event participation request in step S105 or an execution date and time of the processing in step S106.

Then, the generation unit 67 of the event management server 6 generates an event participation notification (step S107). Specifically, the generation unit 67 generates, as the event participation notification, a notification including an event name and a name of a participant of the event that are used to display an event participation dialog (described later), URL information used in a virtual reality hybrid event connection request (described later), and an event ID used in an event participation request (described later). Note that in step S107, the generation unit 67 generates the event participation notification, based on the participation date and time of participation of the communication terminal 3 in the predetermined event. In step S107, the generation unit 67 generates, as the event participation notification, a notification including an event name representing the predetermined event being executed and a name of a participant participating in the predetermined event.

Then, the transmission and reception unit 61 of the event management server 6 transmits the event participation notification generated in step S107 to the PC 9 (step S108). Thus, the transmission and reception unit 91 of the PC 9 receives the event participation notification transmitted by the event management server 6.

FIG. 23E is a sequence diagram illustrating another example of the process including the event participation coordination processing between the communication terminal and the metaverse according to the embodiment. First, the display control unit 94 of the PC 9 causes the display 907 of the PC 9 to display an event participation dialog which is an example of the event participation notification received from the event management server 6 (step S109). Specifically, the display control unit 94 causes the display 907 to display the event participation dialog which is an example of the event participation notification received from the event management server 6. More specifically, the display control unit 94 causes the display 907 to display, as the event participation notification, a dialog to be operated on the PC 9 by the user who uses the PC 9.

Then, the operation receiving unit 92 of the PC 9 receives an event participating operation (step S110). Specifically, the operation receiving unit 92 receives an event participating operation performed by the user who uses the PC 9.

Then, the transmission and reception unit 91 of the PC 9 transmits a virtual reality hybrid event connection request to the virtual reality hybrid event management server 7 (step S111). Thus, the transmission and reception unit 71 of the virtual reality hybrid event management server 7 receives the virtual reality hybrid event connection request transmitted by the PC 9. At this time, the virtual reality hybrid event connection request includes the URL information.

Then, the connection processing unit 78 of the virtual reality hybrid event management server 7 executes virtual reality hybrid event connection processing (step S112).

Then, the transmission and reception unit 71 of the virtual reality hybrid event management server 7 transmits a virtual reality hybrid event connection response to the PC 9 (step S113). Specifically, the transmission and reception unit 71 transmits, as a response to the virtual reality hybrid event connection request received in step S111, a result of the virtual reality hybrid event connection processing executed in step S112. Thus, the transmission and reception unit 91 of the PC 9 receives the virtual reality hybrid event connection response.

Then, the transmission and reception unit 91 of the PC 9 transmits an event participation request to the event management server 6 (step S114). Thus, the transmission and reception unit 61 of the event management server 6 receives the event participation request transmitted by the PC 9. At this time, the event participation request includes the access token, which is one kind of user identification information for identifying the user, and the event ID.

Then, the execution and processing unit 68 of the event management server 6 executes held event participation processing, and the registration unit 66 of the event management server 6 registers held event information (step S115). Specifically, the execution and processing unit 68 executes processing of participating in the predetermined held event. Then, the registration unit 66 registers, for each held event ID managed in the held event management DB 6003 (see FIG. 11), the event ID associated with the user ID included in the access token received in step S114 and the participation date and time. Note that the participation date and time may be a reception date and time of the event participation request in step S114 or an execution date and time of the processing in step S115.

Event Participation Coordination Processing from Metaverse

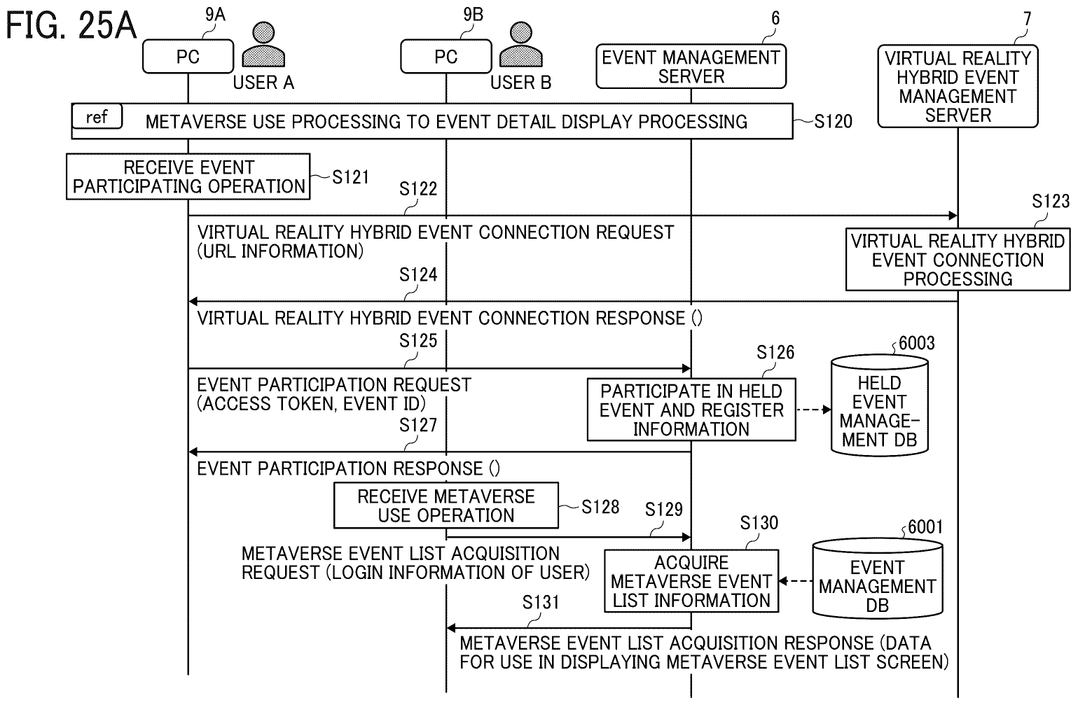

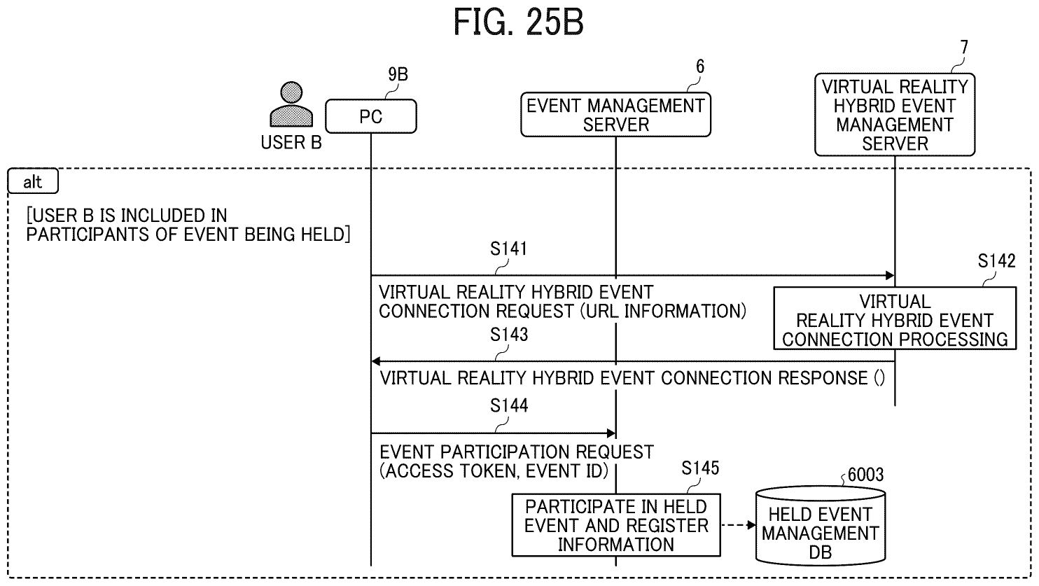

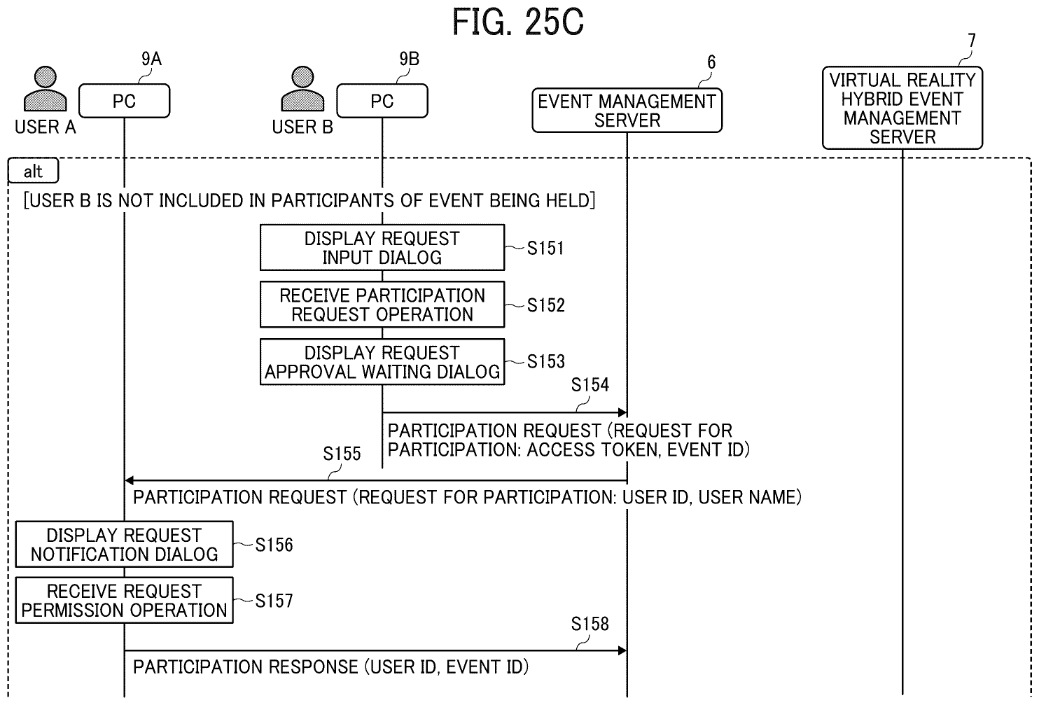

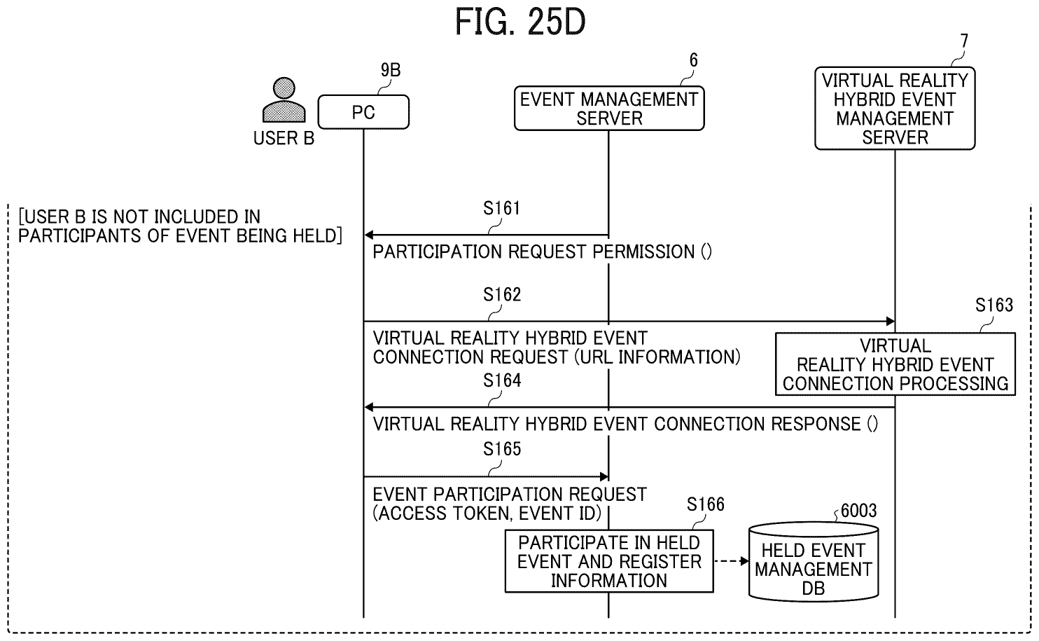

Event participation coordination processing from the metaverse will be described next. FIG. 25A is a sequence diagram illustrating an example of a process including event participation coordination processing from the metaverse according to the embodiment. Note that processing (described later) performed by PCs 9A and 9B is executed by each functional unit denoted by reference signs in 90s illustrated in FIG. 7A.

First, the PCs 9 (PCs 9A and 9B) used by one or more users who use the metaverse and the event management server 6 execute metaverse use processing to event detail display processing (step S120). Note that since the processing of step S120 (steps S61 to S69 and steps S71 to S75) is a combination of the above-described processing (external reference processing), description is omitted.

Then, the operation receiving unit 92 of the PC 9A used by a user A receives an event participating operation (step S121). Specifically, the operation receiving unit 92 receives an event participating operation performed by the user A who uses the PC 9A.

Then, the transmission and reception unit 91 of the PC 9A transmits a virtual reality hybrid event connection request to the virtual reality hybrid event management server 7 (step S122). Thus, the transmission and reception unit 71 of the virtual reality hybrid event management server 7 receives the virtual reality hybrid event connection request transmitted by the PC 9A. At this time, the virtual reality hybrid event connection request includes URL information that is included in the event detail information and indicates the location where a virtual reality hybrid event is executed.

Then, the connection processing unit 78 of the virtual reality hybrid event management server 7 executes virtual reality hybrid event connection processing (step S123). Specifically, based on the URL information received in step S122, the connection processing unit 78 performs the virtual reality hybrid event connection processing.

Then, the transmission and reception unit 71 of the virtual reality hybrid event management server 7 transmits a virtual reality hybrid event connection response to the PC 9A (step S124). Specifically, the transmission and reception unit 71 transmits, as a response to the virtual reality hybrid event connection request received in step S122, the virtual reality hybrid event connection response to the PC 9A. Thus, the transmission and reception unit 91 of the PC 9A receives the virtual reality hybrid event connection response transmitted by the virtual reality hybrid event management server 7.

Then, the transmission and reception unit 91 of the PC 9A transmits an event participation request to the event management server 6 (step S125). Thus, the transmission and reception unit 61 of the event management server 6 receives the event participation request transmitted by the PC 9A. At this time, the event participation request includes the access token, which is one kind of user identification information for identifying the user, and the event ID.

Then, the execution and processing unit 68 of the event management server 6 executes held event participation processing, and the registration unit 66 of the event management server 6 registers held event information (step S126). Specifically, the execution and processing unit 68 executes processing of participating in a predetermined held event. Then, the registration unit 66 registers, for each held event ID managed in the held event management DB 6003 (see FIG. 11), the user ID associated with the event ID received in step S125 and the participation date and time.

Note that the participation date and time may be a reception date and time of the event participation request in step S125 or an execution date and time of the processing in step S126.

Then, the transmission and reception unit 61 of the event management server 6 transmits an event participation response to the PC 9A (step S127). Specifically, the transmission and reception unit 61 transmits, as a response to the event participation request received in step S125, the event participation response to the PC 9A. At this time, the event participation response may include, as contents thereof, any information indicating that the user A has participated in the event.

Then, the operation receiving unit 92 of the PC 9B receives a metaverse use operation performed by a user B (step S128). Specifically, the operation receiving unit 92 receives a use operation on a screen of the metaverse (virtual space) displayed on the PC 9B used by the user B.

Then, the transmission and reception unit 91 of the PC 9B transmits a metaverse event list acquisition request to the event management server 6 (step S129). Thus, the transmission and reception unit 61 of the event management server 6 receives the metaverse event list acquisition request transmitted by the PC 9B. At this time, the metaverse event list acquisition request includes login information (user ID) of the user B who uses the PC 9B.

Then, the acquisition unit 63 of the event management server 6 acquires metaverse event list information (step S130). Specifically, the acquisition unit 63 searches the event management DB 6001 (see FIG. 9) by using, as a search key, the login information (user ID) received in step S129, and acquires corresponding event list information. At this time, the event list information includes event details, a start date and time, an end date and time, and a location link (URL information).

Then, the transmission and reception unit 61 of the event management server 6 transmits a metaverse event list acquisition response to the PC 9B (step S131). Specifically, the transmission and reception unit 61 transmits, as a response to the metaverse event list acquisition request received in step S129, the metaverse event list acquisition response including the metaverse event list information acquired in step S130. Thus, the transmission and reception unit 91 of the PC 9B receives the metaverse event list acquisition response transmitted by the event management server 6. At this time, the metaverse event list acquisition response includes the event ID, the host ID (user ID), the event details, the start date and time, the end date and time, the location link (URL information), and participant information of the event being held.

Processing Performed when User is Included in Participants of Event being Held

Processing performed when the user B is included in participants of the event being held will be described next. FIG. 25B is a sequence diagram illustrating another example of the process including the event participation coordination processing from the metaverse according to the embodiment.

First, the transmission and reception unit 91 of the PC 9B used by the user B who is to participate in the metaverse event transmits a virtual reality hybrid event connection request to the virtual reality hybrid event management server 7 (step S141). Thus, the transmission and reception unit 71 of the virtual reality hybrid event management server 7 receives the virtual reality hybrid event connection request transmitted by the PC 9B. At this time, the virtual reality hybrid event connection request includes the URL information.

Then, the connection processing unit 78 of the virtual reality hybrid event management server 7 executes virtual reality hybrid event connection processing (step S142).

Then, the transmission and reception unit 71 of the virtual reality hybrid event management server 7 transmits a virtual reality hybrid event connection response to the PC 9B (step S143). Specifically, the transmission and reception unit 71 transmits, as a response to the virtual reality hybrid event connection request received in step S141, a result of the virtual reality hybrid event connection processing executed in step S142.

Thus, the transmission and reception unit 91 of the PC 9B receives the virtual reality hybrid event connection response.

Then, the transmission and reception unit 91 of the PC 9B transmits an event participation request to the event management server 6 (step S144). Thus, the transmission and reception unit 61 of the event management server 6 receives the event participation request transmitted by the PC 9B. At this time, the event participation request includes the access token, which is one kind of user identification information for identifying the user, and the event ID.

Then, the execution and processing unit 68 of the event management server 6 executes held event participation processing, and the registration unit 66 of the event management server 6 registers held event information (step S145). Specifically, the execution and processing unit 68 executes processing of participating in a predetermined held event. Then, the registration unit 66 registers, for each held event ID managed in the held event management DB 6003 (see FIG. 11), the user ID associated with the event ID received in step S144 and the participation date and time.

Note that the participation date and time may be a reception date and time of the event participation request in step S144 or an execution date and time of the processing in step S145.

Processing Performed when User is not Included in Participants of Event being Held

Processing performed when the user B is not included in participants of the event being held will be described next. FIG. 25C is a sequence diagram illustrating another example of the process including the event participation coordination processing from the metaverse according to the embodiment.

First, the display control unit 94 of the PC 9B causes a request input dialog to be displayed (step S151). Specifically, the display control unit 94 causes the display 907 of the PC 9B to display the request input dialog. The request input dialog will be described in detail with reference to a screen example below.

Then, the operation receiving unit 92 of the PC 9B receives a participation request operation (step S152). Specifically, the operation receiving unit 92 receives a participation request operation (an operation on a “request button” described later) in the request input dialog displayed in step S151.

Then, the display control unit 94 of the PC 9B causes a request approval waiting dialog to be displayed (step S153). This display processing is executed after the participation request operation is performed in step S152. Specifically, the display control unit 94 causes the display 907 of the PC 9B to display the request approval waiting dialog. The request approval waiting dialog will be described in detail with reference to a screen example below.

Then, the transmission and reception unit 91 of the PC 9B transmits a participation request to the event management server 6 (step S154). Thus, the transmission and reception unit 61 of the event management server 6 receives the participation request transmitted by the PC 9B. At this time, the participation request includes the access token and the event ID that serve as a request for participation.

Then, the transmission and reception unit 61 of the event management server 6 transmits the participation request to the PC 9A used by the user A who is already participating in the virtual reality hybrid event (step S155). Thus, the transmission and reception unit 91 of the PC 9A receives the participation request transmitted by the event management server 6. At this time, the participation request includes the user ID and the user name that serve as a request for participation.

Next, the display control unit 94 of the PC 9A causes a request notification dialog to be displayed (step S156). Specifically, the display control unit 94 causes the display 907 of the PC 9A to display the request notification dialog.

Then, the operation receiving unit 92 of the PC 9A receives a request permission operation (step S157). Specifically, the operation receiving unit 92 receives a request permission operation (an operation on a “permit button” described later) in the request notification dialog displayed in step S156.

Then, the transmission and reception unit 91 of the PC 9A transmits a participation response to the event management server 6 (step S158). Specifically, the transmission and reception unit 91 transmits the participation response, as a response to the participation request that is the request for request received in step S155. Thus, the transmission and reception unit 61 of the event management server 6 receives the participation response transmitted by the PC 9A. At this time, the participation response includes the user ID for which permission is given for the participation request and the event ID for identifying the participating event.

FIG. 25D is a sequence diagram illustrating another example of the process including the event participation coordination processing from the metaverse according to the embodiment.

First, the transmission and reception unit 61 of the event management server 6 gives participation request permission to the PC 9B used by the user B (step S161). Specifically, the transmission and reception unit 61 transmits, as a response to the participation request received in step S154, participation request permission indicating information for permitting the participation request, to the PC 9B used by the user B. Thus, the transmission and reception unit 91 of the PC 9B receives the participation request permission transmitted by the event management server 6.

Then, the transmission and reception unit 91 of the PC 9B transmits a virtual reality hybrid event connection request to the virtual reality hybrid event management server 7 (step S162). Thus, the transmission and reception unit 71 of the virtual reality hybrid event management server 7 receives the virtual reality hybrid event connection request transmitted by the PC 9B. At this time, the virtual reality hybrid event connection request includes a location link (URL information) where a virtual reality hybrid event is executed.

Then, the connection processing unit 78 of the virtual reality hybrid event management server 7 executes virtual reality hybrid event connection processing (step S163). Specifically, based on the URL information received in step S162, the connection processing unit 78 performs the virtual reality hybrid event connection processing.

Then, the transmission and reception unit 71 of the virtual reality hybrid event management server 7 transmits a virtual reality hybrid event connection response to the PC 9B (step S164). Specifically, the transmission and reception unit 71 transmits, as a response to the virtual reality hybrid event connection request received in step S162, the virtual reality hybrid event connection response to the PC 9B. Thus, the transmission and reception unit 91 of the PC 9B receives the virtual reality hybrid event connection response transmitted by the virtual reality hybrid event management server 7.

Then, the transmission and reception unit 91 of the PC 9B transmits an event participation request to the event management server 6 (step S165). Thus, the transmission and reception unit 61 of the event management server 6 receives the event participation request transmitted by the PC 9B. At this time, the event participation request includes the access token, which is one kind of user identification information for identifying the user, and the event ID.

Then, the execution and processing unit 68 of the event management server 6 executes held event participation processing, and the registration unit 66 of the event management server 6 registers held event information (step S166). Specifically, the execution and processing unit 68 executes processing of participating in a predetermined held event. Then, the registration unit 66 registers, for each held event ID managed in the held event management DB 6003 (see FIG. 11), the user ID associated with the event ID received in step S165 and the participation date and time.

Note that the participation date and time may be a reception date and time of the event participation request in step S165 or an execution date and time of the processing in step S166.

### Display Screen Example of Request Input Dialog

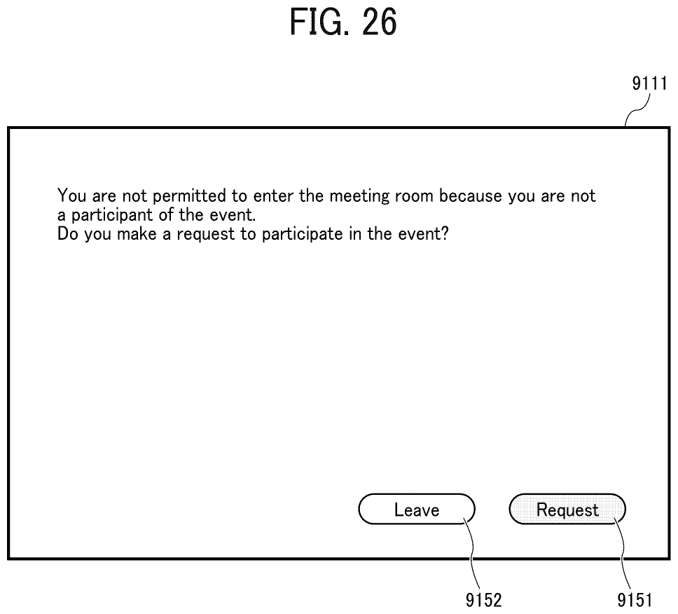

A display screen example in the processing in step S151 above will be described. FIG. 26 is a diagram illustrating an example of the request input dialog according to the embodiment. In FIG. 26, the display control unit 94 of the PC 9B causes a request input dialog 9211 to be displayed. The request input dialog 9211 displays a message indicating that the user B is not a participant of the metaverse event (meeting) and a message asking the user B whether to make a request to participate in the event (meeting). That is, the request input dialog 9211 is an example of a screen that hinders a person other than participants of a schedule being held in a metaverse meeting room from using the metaverse meeting room. The request input dialog 9211 further displays a request button 9251 for making a request to participate in the event, and a leave button 9252 for leaving without participating in the event. Therefore, a user who desires to participate in a predetermined event operates the request button 9251, and thus can make a request to participate in that event.

### Display Screen Example of Request Approval Waiting Dialog

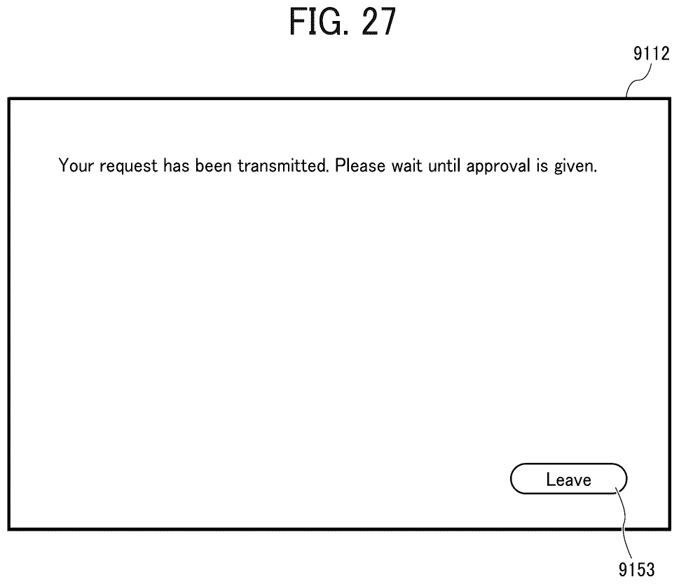

A display screen example in the processing in step S153 above will be described. FIG. 27 is a diagram illustrating an example of the request approval waiting dialog according to the embodiment. In FIG. 27, the display control unit 94 of the PC 9B causes a request approval waiting dialog 9112 to be displayed. The request approval waiting dialog 9112 displays a message indicating that a request has been transmitted and a message prompting the user B of the PC 9B to wait until approval is given. The request approval waiting dialog 9112 also displays a leave button 9153. Therefore, when a user who has performed a request operation in the request input dialog 9211 to participate in an event now desires to cancel the request for some reason, the user can cancel the request.

### Display Screen Example of Request Notification Dialog

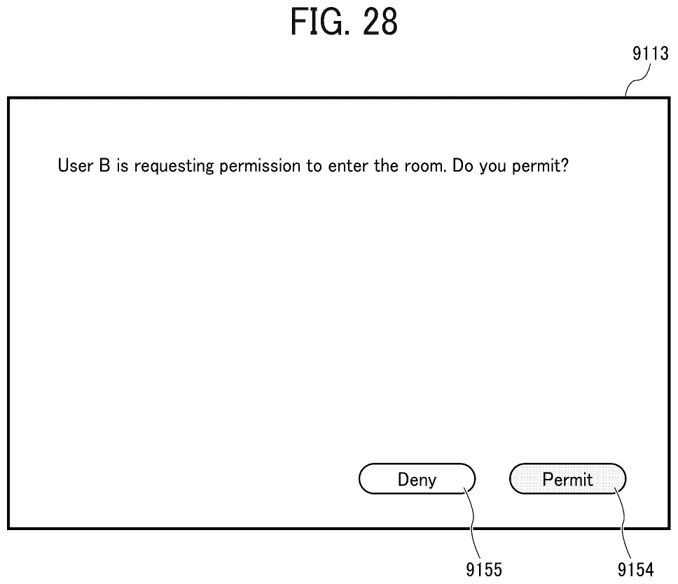

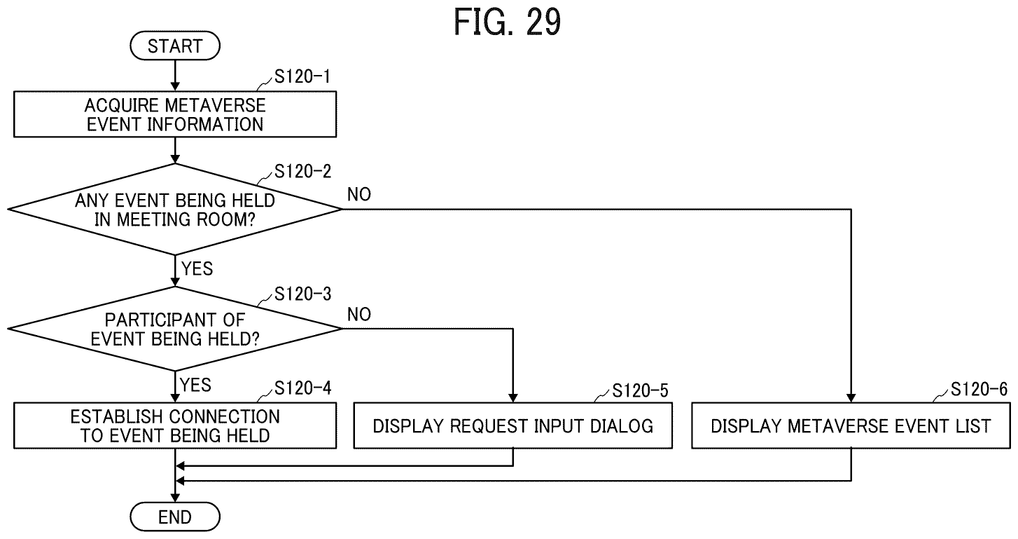

A display screen example in the processing in step S156 above will be described. FIG. 28 is a diagram illustrating an example of the request notification dialog according to the embodiment. In FIG. 28, the display control unit 94 of the PC 9A causes a request notification dialog 9113 to be displayed. The request notification dialog 9113 displays a message prompting the user A of the PC 9A to determine whether to give permission to the user B of the PC 9B who has made the request. The request notification dialog 9113 further displays a permit button 9154 for permitting participation in the event, and a deny button 9155 for denying participation in the event. Therefore, a user participating in a predetermined event can permit or deny participation of a user who has made a request to participate in the event.

### Specific Example of Metaverse Use Processing

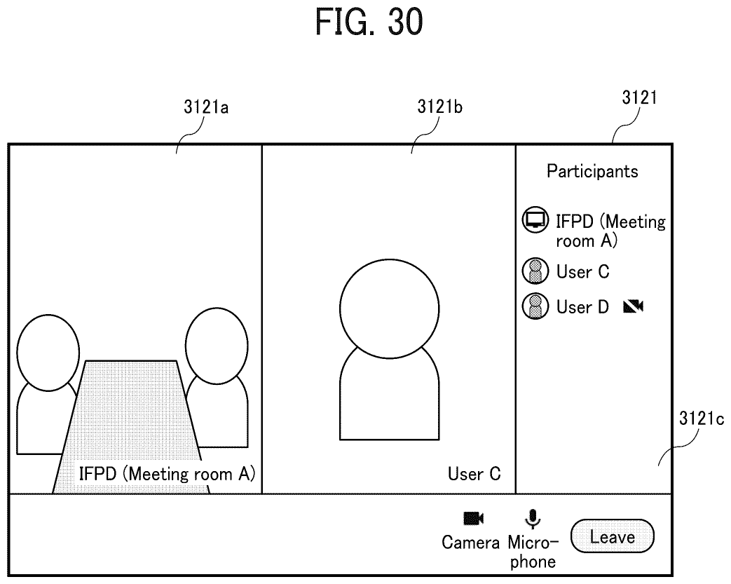

A specific example of the aforementioned metaverse use processing will be described. FIG. 29 is a flowchart illustrating an example of the metaverse use processing according to the embodiment. FIG. 29 describes the metaverse use processing executed in the PC 9B used by the user B who participates in a virtual reality hybrid event using (utilizing) the metaverse. Note that a controlling entity of each processing in step S120 executed as the external reference processing is not limited to the PC 9B, and each processing may be executed by a suitable apparatus or server among the PCs 9 (PCs 9A and 9B) used by one or more users, the event management server 6, and the virtual reality hybrid event management server 7. Note that the flowchart illustrated in FIG. 29 is an example of details of the processing of step S120, and the processing is not limited to this example.

First, the acquisition unit 93 of the PC 9B acquires metaverse event information (step S120-1).

Then, the determination unit 95 of the PC 9B determines whether an event is being held in the meeting room (step S120-2).

If an event is being held in the meeting room (YES in step S120-2), the determination unit 95 of the PC 9B further determines whether the user B of the PC 9B is a participant of the event being held (step S120-3).

If the user B of the PC 9B is a participant of the event being held (YES in step S120-3), the execution control unit 98 establishes a connection to the event being held (step S120-4), and exits from this flowchart.

On the other hand, if the user B of the PC 9B is not a participant of the event being held (NO in step S120-3), the display control unit 94 of the PC 9B causes the display 907 of the PC 9B to display the request input dialog illustrated in FIG. 26 (step S120-5), and exits from this flowchart.

If no event is being held in the meeting room (NO in step S120-2) in the determination processing of step S120-2, the display control unit 94 of the PC 9B causes the display 907 of the PC 9B to display a metaverse event list (step S120-6), and exits from this flowchart.

Example of Screen Displayed when Communication Terminal Participates in Virtual Reality Hybrid Event

An example of a screen displayed during participation in a virtual reality hybrid event will be described. FIG. 30 is a diagram illustrating an example of a screen displayed when the communication terminal participates in a virtual reality hybrid event according to the embodiment. In FIG. 30, for example, the display control unit 34 of the communication terminal 3 (e.g., an IFPD) causes the display 380 to display a virtual reality hybrid event screen 3121. Note that a screen similar to the virtual reality hybrid event screen 3121 is also displayed on the PC 9 used by a user at home. The virtual reality hybrid event screen 3121 has a physical space display area 3121a, a virtual space display area 3121b, and a participant information display area 3121c, which respectively display a meeting room A and participants using the IFPD, a meeting room and an avatar using the metaverse, and participant information. Note that as the participant information, a meeting room name of the physical space (IFPD (meeting room A)) and icons of users (avatars) participating by using the metaverse are displayed. Therefore, the user who uses the virtual reality hybrid event screen 3121 can check at a glance who is participating from which space with what facial expression while a predetermined event (meeting) is held as a virtual reality hybrid event. The virtual reality hybrid event screen 3121 also has a leave button. The leave button allows the user to leave the event (meeting) at any timing.

Example of Screen Displayed when Users Participate in Virtual Reality Hybrid Event

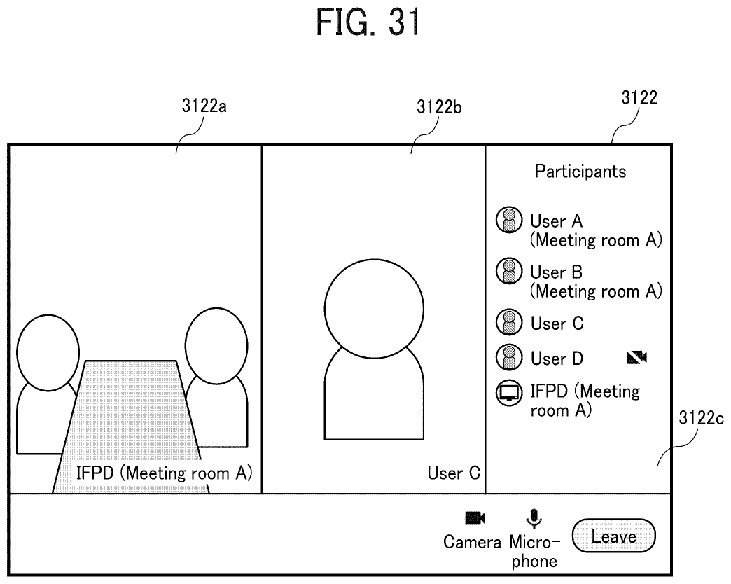

FIG. 31 is a diagram illustrating an example of a screen displayed when users participate in a virtual reality hybrid event according to the embodiment. As in FIG. 30, in FIG. 31, for example, the display control unit 34 of the communication terminal 3 (e.g., an IFPD) causes the display 380 to display a virtual reality hybrid event screen 3122. The virtual reality hybrid event screen 3122 has a physical space display area 3122a, a virtual space display area 3122b, and a participant information display area 3122c, which respectively display a meeting room A and participants using the IFPD, a meeting room and an avatar using the metaverse, and participant information.

Note that the difference between the virtual reality hybrid event screen 3121 and the virtual reality hybrid event screen 3122 is contents displayed in the participant information display areas 3121c and 3122c. The virtual reality hybrid event screen 3121 displays the meeting room name (communication terminal name). In contrast, the virtual reality hybrid event screen 3122 displays information on participants in the meeting room (meeting room A) located in the physical space. These participants are users who have participated in a schedule representing the predetermined event as individual users authenticated by the IFPD. The virtual reality hybrid event screen 3121 (or 3122) including the corresponding information is thus displayed. This allows the users to grasp details of the participation state in the event being held.

Processing of Leaving (Exiting from) Meeting Room in Metaverse

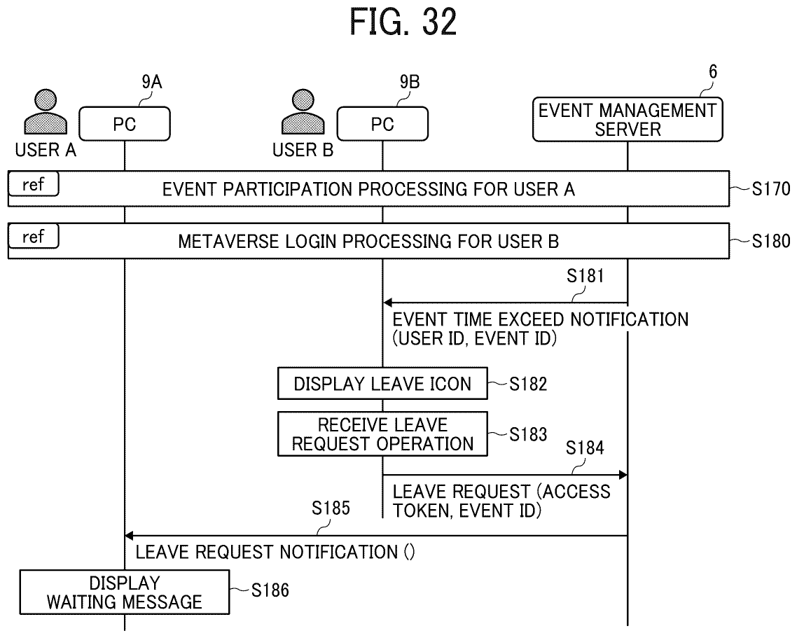

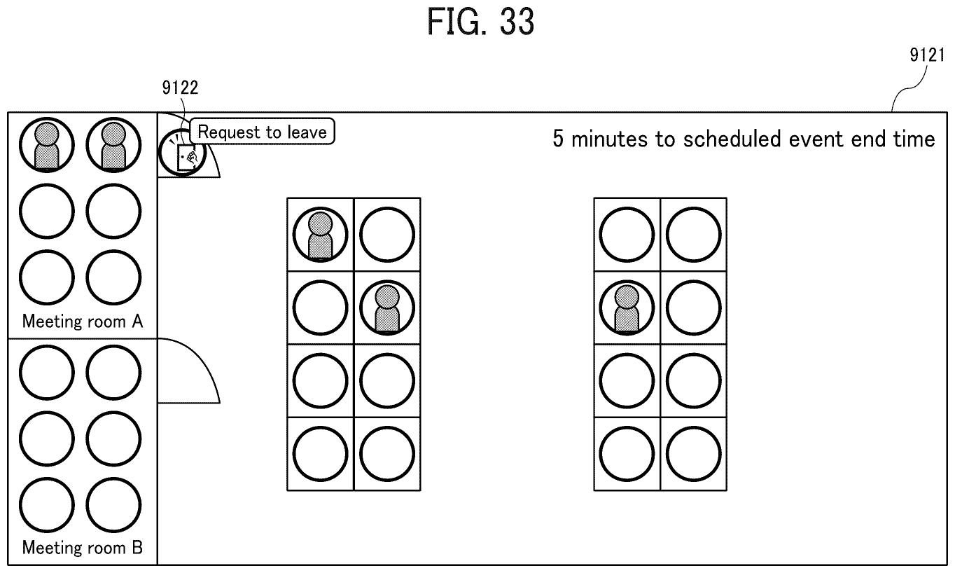

Processing of leaving (exiting from) a meeting room in the metaverse will be described next. FIG. 32 is a sequence diagram illustrating an example of a process including processing of making a request to leave a meeting room in the metaverse according to the embodiment.

First, the PC 9A used by the user A, the PC 9B used by the user B, and the event management server 6 perform event participation processing for the user A, as external reference processing (step S170). Since this processing of step S170 is a combination of the above-described processing as in step S120, description is omitted.

Then, metaverse login processing for the user B is performed (step S180).

Since this processing of step S180 is a combination of the above-described processing as in step S120 and step S170, description is omitted.

Then, the transmission and reception unit 61 of the event management server 6 transmits an event time exceed notification to the PC 9B (step S181). Thus, the transmission and reception unit 91 of the PC 9B receives the event time exceed notification transmitted by the event management server 6. At this time, the event time exceed notification includes the user ID of a metaverse meeting room for which the event end date and time is exceeded and the event ID for identifying an event being held in the metaverse.

Then, the display control unit 94 of the PC 9B causes a leave icon to be displayed (step S182).

Specifically, the display control unit 94 causes the display 907 of the PC 9B to display the leave icon. A screen displaying this leave icon will be described below.

### Display Screen Example of Leave Icon

FIG. 33 is a diagram illustrating an example of a display screen of a leave icon in an overhead view of the virtual space (metaverse) according to the embodiment. In FIG. 33, for example, a state in which the user A participates in a predetermined event (meeting) using (utilizing) a meeting room A located in the physical space is illustrated as a leave request screen 9121. The leave request screen 9121 displays a leave icon 9122 requesting for leaving is displayed near (for example, at a door) of the physical space (the meeting room A) from which the user A participates. The leave request screen 9121 also displays a scheduled end time of the predetermined event (meeting) in which the user A participates. Therefore, another user (user B) who prompts the user A to leave can request the participant to leave, for the meeting room A from which the user A participates.

Referring back to FIG. 32, the operation receiving unit 92 of the PC 9B receives a leave request operation (step S183). Specifically, the operation receiving unit 92 receives a user operation on the leave icon 9122 displayed in the leave request screen 9121 illustrated in FIG. 33.

Then, the transmission and reception unit 91 of the PC 9B transmits a leave request to the event management server 6 (step S184). Thus, the transmission and reception unit 61 of the event management server 6 receives the leave request transmitted by the PC 9B. At this time, the leave request includes the access token and the event ID.

Then, the transmission and reception unit 61 of the event management server 6 transmits a leave request notification to the PC 9A (step S185). Specifically, the transmission and reception unit 61 transmits the leave request notification to the PC 9A of the user A participating in the predetermined event (meeting) using the meeting room A in the physical space. Thus, the transmission and reception unit 91 of the PC 9A receives the leave request notification transmitted by the event management server 6.

Then, the display control unit 94 of the PC 9A causes a waiting message to be displayed (step S186). Specifically, the display control unit 94 causes the display 907 of the PC 9A to display the waiting message in accordance with the leave request notification received in step S185.

### Display Screen Example of Waiting Message

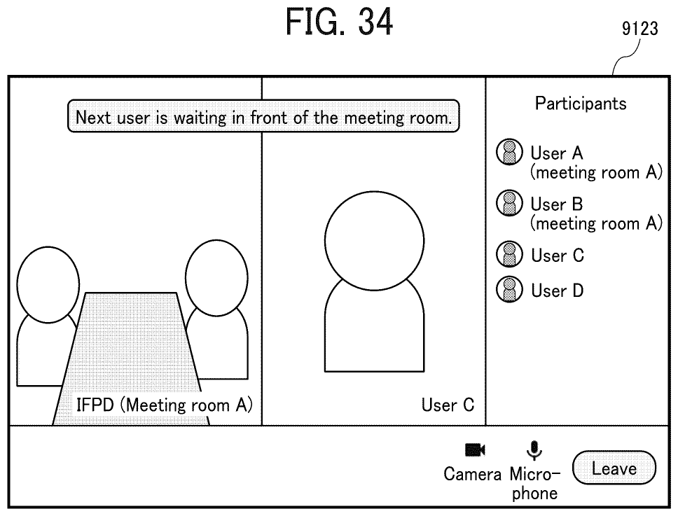

FIG. 34 is a diagram illustrating an example of a display screen of a waiting message according to the embodiment. In FIG. 34, for example, a waiting message display screen 9123 similar to the screen of FIG. 31 is displayed. The waiting message display screen 9123 further displays a popup message indicating that a next user is waiting in front of the meeting room. That is, the waiting message display screen 9123 is an example of a screen indicating issuance of a leave request from the metaverse meeting room when the current time approaches the scheduled end date and time (a predetermined period to the scheduled end date and time) or when the current time exceeds the scheduled end date and time. Therefore, the user (user A) using the meeting room A can recognize that the end time of the meeting is approaching.

As described above, according to the present embodiment, the generation unit 67 of the event management server 6 generates, as the event participation notification, a notification including an event name and a name of a participant of the event that are for use in displaying an event participation dialog, URL information used in a virtual reality hybrid event connection request, and an event ID used in an event participation request (step S87). The transmission and reception unit 61 of the event management server 6 transmits the generated event participation notification to the communication terminal 3 (step S88). Thus, when a predetermined event is executed with the physical space and the virtual space being associated with each other, a participant who participates in one space of the physical space and the virtual space first can participate in the predetermined event without performing some kind of participation processing for the other space.

### Second Embodiment

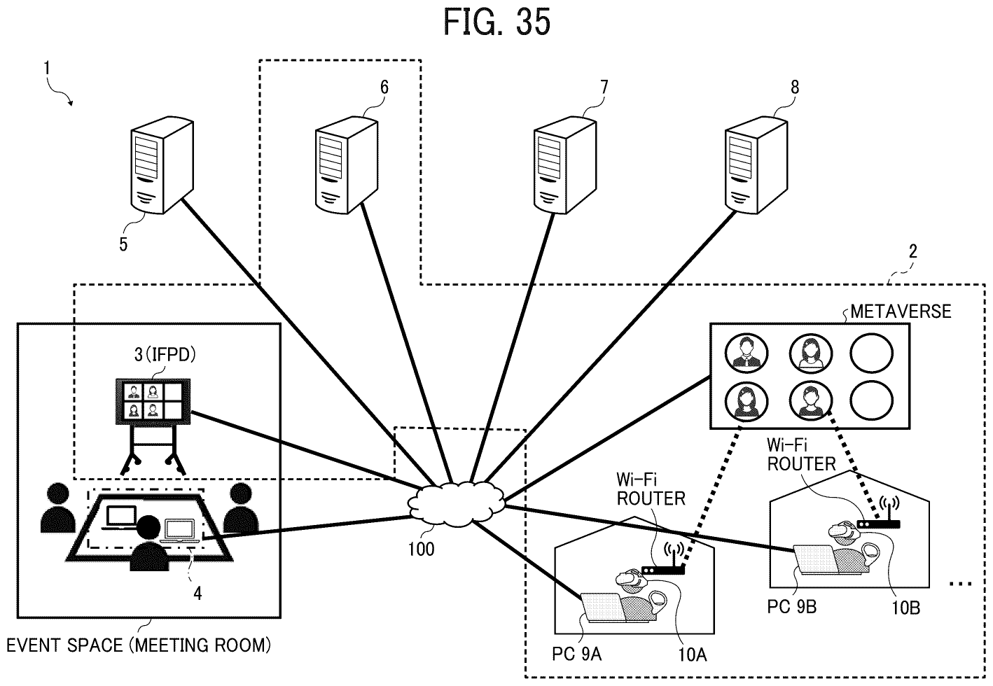

A second embodiment of the present disclosure will be described next. FIG. 35 is a diagram illustrating an example of a general arrangement of an information processing system according to the second embodiment. In the second embodiment, a case will be described where each of users who use one or more PCs 9 (each of which is an example of a second communication terminal) participate in a virtual reality hybrid event while wearing VR goggles 10. The second embodiment is similar to the first embodiment in terms of the system configuration of the information processing system1 and the hardware configuration and the functional configuration of each apparatus and communication terminal described in the first embodiment. Thus, components having like configurations and functions are denoted by the like reference signs, and description thereof is omitted.

As illustrated in FIG. 35, the PC 9 and the VR goggles 10 (10A, 10B, . . . ) at home of each user are connected to a Wi-Fi router at the home of the user via a wireless LAN. An operation controller to be operated by each user is connected to the VR goggles 10 via Bluetooth, for example. The operation controller includes, for example, a menu display button, a pointer display button, and an enter button. The operation controller transmits pressing information on pressing of each of these buttons to the VR goggles 10 via Bluetooth. The VR goggles 10 transfer the pressing information to the metaverse management server 8. The operation controller further includes a six-axis acceleration/angular velocity sensor. The six-axis acceleration/angular velocity sensor detects an orientation and a motion of the operation controller from acceleration data and angular velocity data obtained from this six-axis acceleration/angular velocity sensor, and transmits information on the orientation and the motion to the VR goggles 10 via Bluetooth. The VR goggles 10 transfer the information on the orientation and the motion to the metaverse management server 8. The metaverse management server 8 transmits three-dimensional metaverse screen data to the VR goggles 10. The VR goggles 10 display a screen represented by the transmitted screen data on a display thereof.

On the other hand, the PC 9 transmits screen data to the metaverse management server 8 by using a remote desktop function. The metaverse management server 8 causes the screen data transmitted by the PC 9 to be displayed in the three-dimensional metaverse space, and transmits the updated screen data of the three-dimensional metaverse space to the VR goggles 10. The VR goggles 10 display a screen represented by the transmitted screen data. Thus, each user at home can view, with the VR goggles 10, the screen displayed on the PC 9.

Each user at home wears the corresponding VR goggles 10 (10A, 10B, . . . ), and performs, using the operation controller, an operation on a menu displayed on the display of the VR goggles 10. Thus, each user can enter a meeting room A in the three-dimensional metaverse. The processing operation performed after each user enters the meeting room A is substantially the same as the method described in the first embodiment.

Note that commonly used VR goggles can be used as the VR goggles 10. Thus, detailed description of hardware and functional configurations is omitted in the present embodiment.

### Example of Screen Displayed on VR Goggles

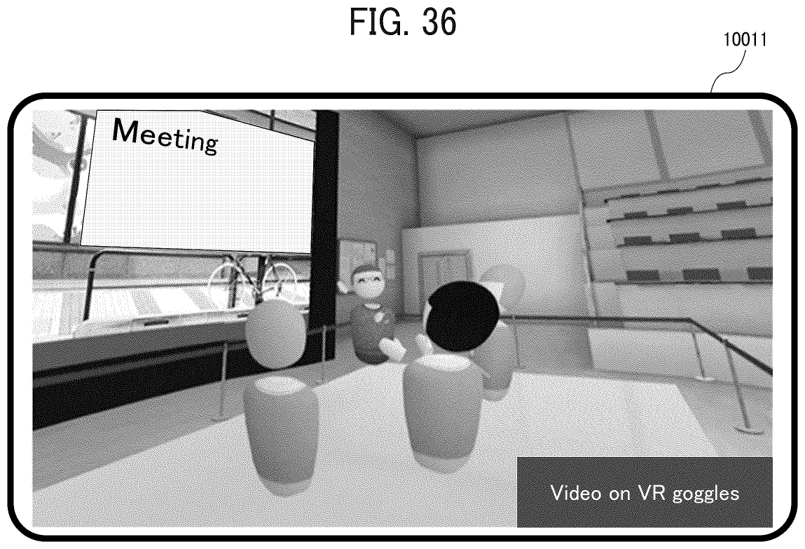

FIG. 36 is a diagram illustrating an example of a three-dimensional metaverse screen displayed on VR goggles according to the second embodiment. In FIG. 36, a metaverse screen 10011 is displayed on an image display portion of the VR goggles 10. In the metaverse screen 10011, avatars of other participants who participate in the same event (meeting) using the metaverse are simultaneously displayed in the meeting room A in the metaverse space serving as a virtual reality hybrid event. Thus, one or more users wearing the VR goggles 10 can participate in the event (meeting) while viewing motions of the avatars of the other participants who participate in the same event (meeting). This enables participation in the event (meeting) with reality.

As described above, according to the present embodiment, users who participate in a virtual reality hybrid event using a metaverse wear VR goggles, which thus enables participation in the event (meeting) with reality.

### Modification of Second Embodiment

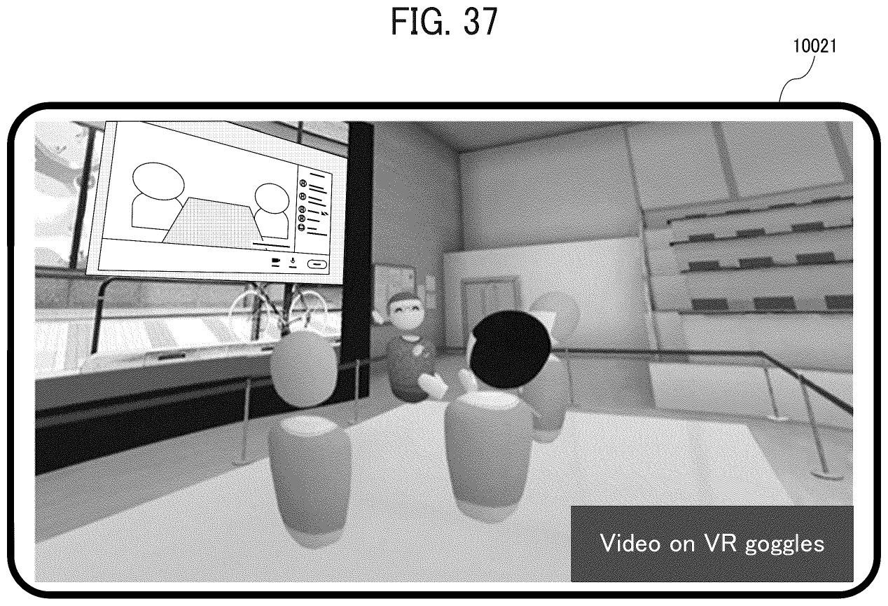

A modification of the second embodiment will be described. FIG. 37 is a diagram illustrating an example of a three-dimensional metaverse screen displayed on VR goggles according to a modification of the second embodiment. As illustrated in FIG. 37, in the modification of the second embodiment, a metaverse screen 10021 is displayed in which the metaverse screen 10011 illustrated in FIG. 36 includes participants who participate from the meeting room A located in the physical space in the display screens illustrated in FIGS. 30, 31, and 34. That is, the metaverse screen 10021 displayed on the VR goggles 10 displays information on users who participate in the event held in the meeting room A located in the physical space as well as the users (avatars) who participate in that event using the virtual space. In other words, in the modification of the second embodiment, a composite (combined) image of an image of the virtual space and an image of the physical space is displayed on a display device (VR goggles) that displays the virtual space. Thus, the image (information) of the virtual space and the image (information) of the physical space can be shared on the VR goggles 10.

As described above, according to the modification of the second embodiment, the users who use the virtual space via VR goggles can be provided with a composite (combined) screen in which avatars of users who are wearing the VR goggles and using the virtual space and participants who participate in a predetermined event by using a meeting room located in the physical space are composed (combined) together in (on) the VR goggles. Therefore, the users who use the virtual space can grasp the details of the held event and can be provided with information with a variation and reality in the held event.

Each of the functions according to the embodiments described above can be implemented by one or more processing circuits or circuitry. The “processing circuit or circuitry” used herein includes a device programmed to execute each function by software, such as a processor implemented by an electronic circuit. The device may be, for example, a processor, an application specific integrated circuit (ASIC) designed to execute the functions described above, a digital signal processor (DSP), a field programmable gate array (FPGA), a system on a chip (SOC), a graphics processing unit (GPU), or a circuit module of the related art.

In the embodiments described above, the information processing system 1 may use machine learning (learning using an artificial intelligence (AI)) to make various determinations in the various kinds of processing described above. This omits the use of the corresponding data tables.

In the present disclosure, the machine learning is defined as a technology that allows a computer to acquire a human-like learning ability. The machine learning refers to a technology in which a computer autonomously generates an algorithm to be used in determination such as data identification from training data input thereto in advance and applies the generated algorithm to new data to make a prediction. Any suitable learning method may be applied to machine learning. For example, any one of supervised learning, unsupervised learning, semi-supervised learning, reinforcement learning, and deep learning may be applied to machine learning. Further, a combination of two or more of these learning methods may be applied to machine learning, and any learning method may be applied to machine learning.

Although the event management system, the event management apparatus, the event management method, and the program according to the embodiments of the present disclosure have been described above, the present disclosure is not limited to the above-described embodiments. Addition of another embodiment, modification, deletion, or the like can be made within the scope conceivable by the person skilled in the art. Any aspect that may exert operations and effects of the present disclosure may be within the scope of the present disclosure.

Aspects of the present disclosure are, for example, as follows.

### Aspect 1

According to Aspect 1, the event management system 2 (an example of an event management system) includes the communication terminal 3 (an example of a first communication terminal), the PC 9 (an example of a second communication terminal), and the event management server 6 (an example of an event management apparatus). The communication terminal 3 is located in a physical space and used for executing a predetermined event. The PC 9 is used for executing the predetermined event via a virtual space. The event management server 6 manages information related to the predetermined event when the predetermined event is executed using the communication terminal 3 and the PC 9. The event management server 6 includes the generation unit 67 (an example of generation means or first circuitry) and the transmission and reception unit 61 (an example of transmission means or the first circuitry). The generation unit 67 generates an event participation notification after one communication terminal of the communication terminal 3 and the PC 9 performs processing of participating in the predetermined event. The event participation notification prompts the other communication terminal of the communication terminal 3 and the PC 9 to participate in the predetermined event. The other communication terminal is scheduled to participate in and does not participate in the predetermined event yet. The transmission and reception unit 61 transmits the generated event participation notification to the other communication terminal.

According to Aspect 1, when the predetermined event is executed with the physical space and the virtual space being associated with each other, a participant who has participated in one space of the physical space and the virtual space first can participate in the predetermined event without performing some kind of participation processing for the other space.

### Aspect 2

According to Aspect 2, in the event management system 2 of Aspect 1, the generation unit 67 of the event management server 6 generates the event participation notification, based on a participation date and time of participation of the one communication terminal of the communication terminal 3 and the PC 9 in the predetermined event.

According to Aspect 2, the same effect as that of Aspect 1 can be attained.

### Aspect 3

According to Aspect 3, in the event management system 2 of Aspect 1 or 2, the generation unit 67 of the event management server 6 generates, as the event participation notification, a notification including an event name representing the predetermined event being executed and a name of a participant participating in the predetermined event.

According to Aspect 3, in addition to the effect attained in Aspect 1 or 2, a scheduled participant of the predetermined event can be provided with more detailed information.

### Aspect 4

According to Aspect 4, in the event management system 2 of any one of Aspects 1 to 3, the other communication terminal, of the communication terminal 3 and the PC 9, to which the event participation notification is transmitted includes the transmission and reception unit 31 or 91 (an example of reception means or second circuitry) and the display control unit 34 or 94 (an example of display control means or the second circuitry). The transmission and reception unit 31 or 91 receives the event participation notification transmitted from the event management server 6. The display control unit 34 or 94 causes the display 380 or 907 (an example of display means or a display) to display the received event participation notification.

According to Aspect 4, a scheduled participant of the predetermined event can check a detailed event participation notification.

### Aspect 5

According to Aspect 5, in the event management system 2 of Aspect 4, the display control unit 34 or 94 causes the display to display, as the event participation notification, a dialog to be operated on the other communication terminal of the communication terminal 3 and the PC 9 by a user of the other communication terminal of the communication terminal 3 and the PC 9.

According to Aspect 5, a scheduled participant of the predetermined event can perform a desired operation on the displayed event participation notification.

### Aspect 6

According to Aspect 6, in the event management system 2 of any one of Aspects 1 to 5, the event management server 6 further includes the registration unit 66 (an example of registration means or the first circuitry). The registration unit 66 registers user identification information and participation date and time information in association with each other. The user identification information is included in a request to participate in the predetermined event. The request is transmitted from the communication terminal 3. The participation date and time information indicates a participation date and time of participation of the communication terminal 3 in the predetermined event.

According to Aspect 6, the same effect as that of Aspect 1 can be attained.

### Aspect 7

According to Aspect 7, in the event management system 2 of any one of Aspects 1 to 5, the event management server 6 further includes the execution and processing unit 68 (an example of execution means or the first circuitry). The execution and processing unit 68 executes participation processing for the predetermined event. The execution and processing unit 68 executes processing of participating in the predetermined event based on a request from the communication terminal 3, for one of a schedule associated with the communication terminal 3 and a schedule associated with a user who participates in the predetermined event executed in the physical space. The execution and processing unit 68 executes processing of participating in the predetermined event based on a request from the PC 9, for one of a schedule associated with the PC 9, a schedule associated with a user who participates in the predetermined event executed in the virtual space, and a schedule represented by the predetermined event being executed.

According to Aspect 7, the same effect as that of Aspect 1 can be attained.

### Aspect 8

According to Aspect 8, in the event management system 2 of any one of Aspects 1 to 7, the predetermined event executed in the event management system 2 includes a conference, a meeting, a lecture, and a class conducted in the physical space and the virtual space in a same time slot.

According to Aspect 8, the same effect as that of Aspect 1 can be attained for various events.

### Aspect 9

According to Aspect 9, the event management server 6 (an example of an event management apparatus) manages information related to a predetermined event in a case where the predetermined event is executed using the communication terminal 3 (an example of a first communication terminal) and the PC 9 (an example of a second communication terminal). The communication terminal 3 is located in a physical space and to be used for executing the predetermined event. The PC 9 is to be used for executing the predetermined event via a virtual space. The event management server 6 includes the generation unit 67 (an example of generation means) and a transmission and reception unit 61 (an example of transmission means). The generation unit 67 generates an event participation notification after one communication terminal of the communication terminal 3 and the PC 9 performs processing of participating in the predetermined event. The event participation notification prompts the other communication terminal of the communication terminal 3 and the PC 9 to participate in the predetermined event. The other communication terminal is scheduled to participate in and does not participate in the predetermined event yet. The transmission and reception unit 61 transmits the generated event participation notification to the other communication terminal.

According to Aspect 9, as in Aspect 1, when the predetermined event is executed with the physical space and the virtual space being associated with each other, a participant who has participated in one space of the physical space and the virtual space first can participate in the predetermined event without performing some kind of participation processing for the other space.

### Aspect 10

According to Aspect 10, an event management method is performed by an event management server 6 (an example of an event management apparatus) that manages information related to a predetermined event in a case where the predetermined event is executed using the communication terminal 3 (an example of a first communication terminal) and the PC 9 (an example of a second communication terminal). The communication terminal 3 is located in a physical space and used for executing the predetermined event. The PC 9 is used for executing the predetermined event via a virtual space. The event management method includes generating an event participation notification after one communication terminal of the communication terminal 3 and the PC 9 performs processing of participating in the predetermined event, the event participation notification being a notification prompting the other communication terminal of the communication terminal 3 and the PC 9 to participate in the predetermined event, the other communication terminal being a communication terminal that is scheduled to participate in and does not participate in the predetermined event yet; and transmitting the generated event participation notification to the other communication terminal.

According to Aspect 10, as in Aspect 1, when the predetermined event is executed with the physical space and the virtual space being associated with each other, a participant who has participated in one space of the physical space and the virtual space first can participate in the predetermined event without performing some kind of participation processing for the other space.

### Aspect 11

According to Aspect 11, a non-transitory recording medium storing a plurality of instructions which, when executed by one or more processors, causes the one or more processors to perform a method, the one or more processors being included in an event management server 6 (an example of an event management apparatus) to execute a process. The event management server 6 manages information related to a predetermined event in a case where the predetermined event is executed using a communication terminal 3 (an example of a first communication terminal, which is omitted below) and a PC 9 (an example of a second communication terminal, which is omitted below). The communication terminal 3 is located in a physical space and to be used for executing the predetermined event. The PC 9 is to be used for executing the predetermined event via a virtual space. The method includes generating an event participation notification after one communication terminal of the communication terminal 3 and the PC 9 performs processing of participating in the predetermined event, the event participation notification being a notification prompting the other communication terminal of the communication terminal 3 and the PC 9 to participate in the predetermined event, the other communication terminal being a communication terminal that is scheduled to participate in but has not participated in the predetermined event; and transmitting the generated event participation notification to the other communication terminal.

According to Aspect 11, as in Aspect 1, when the predetermined event is executed with the physical space and the virtual space being associated with each other, a participant who has participated in one space of the physical space and the virtual space first can participate in the predetermined event without performing some kind of participation processing for the other space.

According to a technique of the related art, when a predetermined event is executed with a physical space and a virtual space being associated with each other, a participant who has participated in one space of the physical space and the virtual space first has to perform some kind of participation processing for the other space, which is troublesome.

According to one or more embodiments, when a predetermined event is executed with a physical space and a virtual space being associated with each other, a participant who has participated in one space of the physical space and the virtual space first can participate in the predetermined event without performing some kind of participation processing for the other space.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An event management system comprising:
a first communication terminal located in a physical space and to be used for executing a predetermined event;
a second communication terminal to be used for executing the predetermined event via a virtual space; and
an event management apparatus to manage information related to the predetermined event in a case where the predetermined event is executed using the first communication terminal and the second communication terminal, wherein
the event management apparatus includes first circuitry configured to:
generate an event participation notification after one communication terminal of the first communication terminal and the second communication terminal performs processing of participating in the predetermined event, the event participation notification being a notification prompting another communication terminal of the first communication terminal and the second communication terminal to participate in the predetermined event, the other communication terminal being a communication terminal that is scheduled to participate in and does not participate in the predetermined event yet; and
transmit the generated event participation notification to the other communication terminal.

2. The event management system according to claim 1, wherein the first circuitry generates the event participation notification, based on a participation date and time of participation of the one communication terminal of the first communication terminal and the second communication terminal in the predetermined event.

3. The event management system according to claim 1, wherein the first circuitry generates, as the event participation notification, a notification including an event name representing the predetermined event being executed and a name of a participant participating in the predetermined event.

4. The event management system according to claim 1, wherein the other communication terminal, of the first communication terminal and the second communication terminal, to which the event participation notification is transmitted, includes second circuitry configured to:
receive the event participation notification transmitted from the event management apparatus; and
control a display to display the received event participation notification.

5. The event management system according to claim 4, wherein the second circuitry controls the display to display, as the event participation notification, a dialog to be operated on the other communication terminal of the first communication terminal and the second communication terminal by a user of the other communication terminal of the first communication terminal and the second communication terminal.

6. The event management system according to claim 1, wherein the first circuitry of the event management apparatus is further configured to register user identification information and participation date and time information in association with each other, the user identification information being included in a request to participate in the predetermined event, the request being transmitted from the first communication terminal, the participation date and time information indicating a participation date and time of participation of the first communication terminal in the predetermined event.

7. The event management system according to claim 1, wherein the first circuitry of the event management apparatus is further configured to:
execute processing of participating in the predetermined event based on a request from the first communication terminal, for one of a schedule associated with the first communication terminal and a schedule associated with a user who participates in the predetermined event executed in the physical space; and
execute processing of participating in the predetermined event based on a request from the second communication terminal, for one of a schedule associated with the second communication terminal, a schedule associated with a user who participates in the predetermined event executed in the virtual space, and a schedule represented by the predetermined event being executed.

8. The event management system according to claim 1, wherein the predetermined event includes a conference, a meeting, a lecture, and a class conducted in the physical space and the virtual space in a same time slot.

9. An event management method performed by an event management apparatus, comprising:
managing information related to a predetermined event in a case where the predetermined event is executed using a first communication terminal and a second communication terminal, the first communication terminal being a communication terminal located in a physical space and to be used for executing the predetermined event, the second communication terminal being a communication terminal to be used for executing the predetermined event via a virtual space;
generating an event participation notification after one communication terminal of the first communication terminal and the second communication terminal performs processing of participating in the predetermined event, the event participation notification being a notification prompting another communication terminal of the first communication terminal and the second communication terminal to participate in the predetermined event, the other communication terminal being a communication terminal that is scheduled to participate in and does not participate in the predetermined event yet; and
transmitting the generated event participation notification to the other communication terminal.

10. A non-transitory recording medium storing a plurality of instructions which, when executed by one or more processors, causes the one or more processors to perform a method, the one or more processors being included in an event management apparatus, the method comprising:
managing information related to a predetermined event in a case where the predetermined event is executed using a first communication terminal and a second communication terminal, the first communication terminal being a communication terminal located in a physical space and to be used for executing the predetermined event, the second communication terminal being a communication terminal to be used for executing the predetermined event via a virtual space;
generating an event participation notification after one communication terminal of the first communication terminal and the second communication terminal performs processing of participating in the predetermined event, the event participation notification being a notification prompting another communication terminal of the first communication terminal and the second communication terminal to participate in the predetermined event, the other communication terminal being a communication terminal that is scheduled to participate in and does not participate in the predetermined event yet; and
transmitting the generated event participation notification to the other communication terminal.
